(19) United States
(12) Patent Application Publication
(10) Pub. No.: US 2024/0314883 A1
(43) Pub. Date: Sep. 19, 2024

(54) METHODS FOR RADIO ACCESS NETWORK (RAN) NODE IDENTITY DISAMBIGUATION FROM INACTIVE RADIO NETWORK TEMPORARY IDENTIFIER (I-RNTI)

(71) Applicant: Telefonaktiebolaget LM Ericsson (publ), Stockholm (SE)

(72) Inventors: Luca LUNARDI, Genoa (IT); Angelo CENTONZA, Granada (ES); Markus DREVÖ, Linköping (SE); Tahmineh Torabian ESFAHANI, Sollentuna (SE)

(21) Appl. No.: 18/271,577

(22) PCT Filed: Jan. 12, 2022
(86) PCT No.: PCT/IB2022/050215

§ 371 Date: Jul. 10, 2023

Related U.S. Application Data
(60) Provisional application No. 63/136,481, filed on Jan. 12, 2021.

(51) Int. Cl. H04W 76/27

(52) U.S. Cl. CPC H04W 76/27

(57) ABSTRACT

A method performed by a first network node includes determining one or more Local node Identifiers. The method includes transmitting the one or more Local node Identifiers to a second network node neighboring the first network node, each of the one or more Local node Identifiers including: an Inactive-Radio Network Temporary Identifier, I-RNTI, profile valid for the first network node and associated with a full I-RNTI; and/or an I-RNTI profile valid for the first network node and associated with a short I-RNTI. The method includes transmitting a radio resource control, RRC, release message with suspend configuration to a user equipment, to transition the user equipment to RRC Inactive, the RRC release message including a Local node Identifier for the first network node and a UE context identifier.

### TECHNICAL FIELD

The present disclosure relates generally to communications, and more particularly to communication methods and related devices and nodes supporting wireless communications.

### BACKGROUND

### 5th Generation (5G) Radio Access Network (RAN) Architecture

The current 5G RAN (NG-RAN) architecture is depicted and described in TS 38.401 v 15.4.0. The overall architecture is illustrated in FIG. 1. The next generation (NG) architecture can be further described as follows. The NG-RAN consists of a set of gNBs connected to the 5G core (5GC) through the NG interface. An gNB can support frequency division duplex (FDD) mode, time division duplex (TDD) mode or dual mode operation. gNBs can be interconnected through the Xn interface. A gNB may consist of a gNB-CU (gNB-centralized unit) and gNB-DUs (gNB-distributed units). A gNB-CU and a gNB-DU are connected via the F1 logical interface. One gNB-DU is connected to only one gNB-CU. For resiliency, a gNB-DU may be connected to multiple gNB-CU by appropriate implementation. NG, Xn and F1 are logical interfaces. The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

A gNB may also be connected to an long term evolution (LTE) E-UTRAN (evolved universal terrestrial radio access network) nodeB (eNB) via the X2 interface. Another architectural option is that where an LTE eNB connected to the Evolved Packet Core (EPC) network is connected over the X2 interface with a so called nr-gNB. The latter is a gNB not connected directly to a core network (CN) and connected via X2 to an eNB for the sole purpose of performing dual connectivity.

The architecture in FIG. 1 can be expanded by spitting the gNB-CU into two entities. One gNB-CU-UP, which serves the user plane and hosts the packet data convergence protocol (PDCP) protocol and one gNB-CU-CP, which serves the control plane and hosts the PDCP and radio resource control (RRC) protocol. For completeness it should be said that a gNB-DU hosts the RLC/MAC/PHY radio link control/medium access control/physical protocols.

### NR Radio Resource Control (RRC) Inactive State

For NR Radio Access (NR), the 3rd generation partnership project (3GPP) has defined three RRC states for UE state machine, namely: RRC_IDLE, RRC_CONNECTED and RRC_INACTIVE. The UE state machine and state transition in NR is shown in FIG. 2.

Provided that signalling radio bearer 2 (SRB2) and at least one dedicated radio bearer (DRB) are setup for the user equipment (UE), the NG-RAN (gNB) can initiate a state transition from RRC_CONNECTED to RRC_INACTIVE or from RRC_INACTIVE back to RRC_INACTIVE when the UE tries to resume.

The state transitions are triggered when a (source) gNB initiate an RRC connection release procedure and sends to the UE an RRC Release message which includes the suspension of the established radio bearers.

The state transition from RRC_INACTIVE to RRC_CONNECTED can be triggered by many reasons. In all cases, this will result in an RRC connection Resume procedure (Resume), initiated by the UE. If the reason for Resume is the need to transfer data (or NAS signaling) towards the UE in downlink, the Resume procedure is preceded by a Paging.

The UE starts the Resume by sending an RRCResumeRequest (on logical channel CCCH) or an RRCResumeRequest1 (on logical channel CCCH1), depending respectively on absence or presence of useFullResumeID IE in SIB1 of the serving NR cell. Note that the UE can attempt a Resume towards an NR cell controlled by the same original (source) gNB or a different (target) gNB. Source gNB and target gNB may or not have an established Xn connection between them.

### Inactive Radio Network Temporary Identifier I-RNTI

A definition for the I-RNTI can be found in 3GPP Technical Specification (TS) 38.423 v16.4.0, clause 9.2.3.46, reproduced in part below:

### 9.2.3.46 I-RNTI

The I-RNTI is defined for allocation in an NR or E-UTRA serving cell as a reference to a UE Context within an NG-RAN node. The I-RNTI is partitioned into two parts, the first part identifies the NG-RAN node that allocated the I-RNTI and the second part identifies the UE context stored in this NG-RAN node.

| | | | | |
|---|---|---|---|---|
| | | | IE type and | Semantics |
| IE/Group Name | Presence | Range | reference | description |

| | | | |
|---|---|---|---|
| CHOICE I-RNTI | | | |
| >I-RNTI full | | | |
| >>I-RNTI full | M | BIT STRING (SIZE | This IE is used to |
| | | (40)) | identify the suspended |
| | | | UE context of a UE in |
| | | | RRC_INACTIVE |
| | | | using 40 bits (refer to |
| | | | I-RNTI-Value IE in TS |
| | | | 38.331 [10] and I- |
| | | | RNTI IE in TS 36.331 |
| | | | [14]). |
| >I-RNTI short | | | |
| >>I-RNTI short | M | BIT STRING (SIZE | This IE is used to |
| | | (24)) | identify the suspended |
| | | | UE context of a UE in |
| | | | RRC_INACTIVE |
| | | | using 24 bits (refer to |
| | | | ShortI-RNTI-Value IE |
| | | | in TS 38.331 [10] and |
| | | | ShortI-RNTI IE in TS |
| | | | 36.331 [14]). |

Moreover, informative text is provided in 3GPP TS 38.300 v16.4.0, Annex C, concerning the I-RNTI Reference Profile. No normative text has been approved yet that stipulates the structure of the I-RNTI, which is left to network configuration.

The text from 3GPP TS 38.300 v16.4.0 is reported below:
Annex C (informative):
I-RNTI Reference Profiles
The I-RNTI provides the new NG-RAN node a reference to the UE context in the old NG-RAN node. How the new NG-RAN node is able to resolve the old NG-RAN ID from the I-RNTI is a matter of proper configuration in the old and new NG-RAN node.
Table C-1 below provides some typical partitioning of a 40 bit I-RNTI, assuming the following content:
   UE specific reference: reference to the UE context within a logical NG-RAN node;
   NG-RAN node address index: information to identify the NG-RAN node that has allocated the UE specific part;
NOTE:RAT-specific information may be introduced in a later release, containing information to identify the RAT of the cell within which the UE was sent to RRC_INACTIVE. This version of the specification only supports intra-RAT mobility of UEs in RRC_INACTIVE.
   Public Land Mobile Network (PLMN)-specific information: information supporting network sharing deployments, providing an index to the PLMN ID part of the Global NG-RAN node identifier.

TABLE C-1
I-RNTI reference profiles

| | | NG-RAN | | | |
|---|---|---|---|---|---|
| | | node address | RAT- | PLMN- | |
| Profile | UE specific | index (e.g., | specific | specific | |
| ID | reference | gNB ID, eNB ID) | information | information | Comment |
| 1 | 20 bits | 20 bits | N/A | N/A | NG-RAN node |
| | (~1 million | (~1 million | | | address index may |
| | values) | values) | | | be very well |
| | | | | | represented by the |
| | | | | | LSBs of the gNB ID. |
| | | | | | This profile may |
| | | | | | be applicable for |
| | | | | | any NG-RAN RAT. |
| 2 | 20 bits | 16 bits | N/A | 4 bits (Max | Max number of |
| | (~1 million | (65.000 | | 16 PLMNs) | PLMN IDs |
| | values) | nodes) | | | broadcast in NR is |
| | | | | | 12. |
| | | | | | This profile may |
| | | | | | be applicable for |
| | | | | | any NG-RAN RAT. |
| 3 | 24 bits | 16 bits | N/A | N/A | Reduced node |
| | (16 million | (65.000 | | | address to |
| | values) | nodes) | | | maximise |
| | | | | | addressable UE |
| | | | | | contexts. |
| | | | | | This profile may |
| | | | | | be applicable for |
| | | | | | any NG-RAN RAT. |

### Global NG RAN Node ID

The Global NG-RAN Node ID is defined in TS 38.423 v16.4.0, clause 9.2.2.3.

### 9.2.2.3 Global NG-RAN Node ID

This IE is used to globally identify an NG-RAN node (see TS 38.300 [9]).

| | | | | |
|---|---|---|---|---|
| | | | IE type and | Semantics |
| IE/Group Name | Presence | Range | reference | description |

| | | |
|---|---|---|
| CHOICE NG-RAN | M | |
| node | | |
| >gNB | | |
| >>Global gNB ID | M | 9.2.2.1 |
| >ng-eNB | | |
| >>Global ng-eNB | M | 9.2.2.2 |
| ID | | |

### 9.2.2.1 Global gNB ID

This IE is used to globally identify a gNB (see TS 38.300 [9]).

| | | | | |
|---|---|---|---|---|
| | | | IE type and | Semantics |
| IE/Group Name | Presence | Range | reference | description |

| | | | |
|---|---|---|---|
| PLMN Identity | M | 9.2.2.4 | |
| CHOICE gNB ID | M | | |
| >gNB ID | | | |
| >>gNB ID | M | BIT STRING | Equal to the leftmost |
| | | (SIZE(22 . . . 32)) | bits of the NR Cell |
| | | | Identity IE contained in |
| | | | the NR cell global |
| | | | identifer (CGI) IE of |
| | | | each cell served by the |
| | | | gNB. |

### 9.2.2.2 Global Ng-eNB ID

This IE is used to globally identify an ng-eNB (see TS 38.300 [9]).

| | | | | |
|---|---|---|---|---|
| | | | IE type and | Semantics |
| IE/Group Name | Presence | Range | reference | description |

| | | | |
|---|---|---|---|
| PLMN Identity | M | 9.2.2.4 | |
| CHOICE ng-eNB ID | M | | |
| >Macro ng-eNB ID | | | |
| >>Macro ng-eNB | M | BIT STRING | Equal to the 20 |
| ID | | (SIZE(20)) | leftmost bits of the E- |
| | | | UTRA Cell Identity IE |
| | | | contained in the E- |
| | | | UTRA CGI IE of each |
| | | | cell served by the ng- |
| | | | eNB. |
| >Short Macro ng- | | | |
| eNB ID | | | |
| >>Short Macro ng- | M | BIT STRING | Equal to the 18 |
| eNB ID | | (SIZE(18)) | leftmost bits of the E- |
| | | | UTRA Cell Identity IE |
| | | | contained in the E- |
| | | | UTRA CGI IE of each |
| | | | cell served by the ng- |
| | | | eNB. |
| >Long Macro ng- | | | |
| eNB ID | | | |
| >>Long Macro ng- | M | BIT STRING | Equal to the 21 |
| eNB ID | | (SIZE(21)) | leftmost bits of the E- |
| | | | UTRA Cell Identity IE |
| | | | contained in the E- |
| | | | UTRA CGI IE of each |
| | | | cell served by the ng- |
| | | | eNB. |

One problem that can occur with the use of the I-RNTI has been described in R3-206967 discussed at RAN3 #110-e meeting and reported below:
“The problem concerns the process of RRC resume and the disambiguation of the RAN node from which a UE context needs to be retrieved from the I-RNTI signalled by the UE at RRC resume.
The issue is that the I-RNTI identifier signalled by the UE at RRC resume has no standardized structure and therefore it does not allow for an inter-vendor interoperable identification of the source gNB. Namely, it is not possible to deduce from the I-RNTI the identifier from which the source node identity should be derived.
Obviously, each vendor can resolve the I-RNTI (and deduce the source gNB identity) by means of proprietary mechanisms. With this approach, RRC_INACTIVE can be supported between gNBs of the same vendor, but this does not work at the borders of geographical areas covered by gNBs of different vendors.”

At RAN3 #110-e meeting, contributions R3-206246 and R3-206249 have been submitted, where it has been proposed to add to XnAP signaling a local-NG-RAN-Node-ID and a local-NG-RAN-Node-ID-Length.

Finally, at RAN3 #110-e the following has been agreed:
“A standardized solution enabling an inter vendor interoperable way for an NG RAN node to deduce the identity of another NG RAN node from the received I-RNTI is needed
Agree on the benefits of a solution that allows at least some flexibility in the selection of the Local Node ID length; further details FFS”

### SUMMARY

One problem that exists with the solution proposed in R3-206246 and R3-206249 is that it is unclear how a gNB receiving an I-RNTI can disambiguate the gNB ID of the gNB hosting the UE context.

An example of a problematic situation that can occur is shown in FIG. 2 and described below:
1) Three gNBs use different values for the local-NG-RAN-Node-ID-Length, respectively: for “gNB A” local-NG-RAN-Node-ID-Length=10, for “gNB B” local-NG-RAN-Node-ID-Length=15, for “gNB C” local-NG-RAN-Node-ID-Length=20.
2) All the gNBs have full knowledge of the local-NG-RAN-Node-ID-Length of the other gNBs.
3) UE1 is released to RRC Inactive from “gNB A” and assigned an I-RNTI comprising a local-NG-RAN-Node-ID which is 10 bits long.
4) UE2 is released to RRC Inactive from “gNB C” and assigned an I-RNTI comprising a local-NG-RAN-Node-ID which is 20 bits long.
5) UE1 moves to a cell served by “gNB B” and attempts to resume. The “gNB B” receives the I-RNTI from UE1.
6) UE2 moves to a cell served by “gNB B” and attempts to resume. The “gNB B” receives the I-RNTI from UE2.
7) Without any further information available at the “gNB B”, the “gNB B” is not able to deduce if UE1 or UE2 received the I-RNTI from “gNB A” or from “gNB C” and with that it is not able to deduce how many most significant bits of the I-RNTI should be taken into account to derive the Local gNB ID identifying the RAN node from which the UE context needs to be retrieved.

Various embodiments of inventive concepts address some of these problems.

According to some of the various embodiments, a method performed by a first network node includes determining one or more Local node Identifiers. The method includes transmitting the one or more Local node Identifiers to a second network node neighboring the first network node, each of the one or more Local node Identifiers comprising: an Inactive-Radio Network Temporary Identifier, I-RNTI, profile valid for the first network node and associated with a full I-RNTI; or an I-RNTI profile valid for the first network node and associated with a short I-RNTI. The method includes transmitting a radio resource control, RRC, release message with suspend configuration to a user equipment, to transition the user equipment to RRC Inactive, the RRC release message comprising a Local node Identifier for the first network node and a UE context identifier.

Analogous network nodes, computer programs, and computer program products are provided in other embodiments.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustrated of the overall architecture of a 5G RAN according to some embodiments;

FIG. 2 is an illustration of a UE state machine and state transitions in NR according to some embodiments;

FIG. 3 is an illustration of a limitation for a solution previously proposed according to some embodiments;

FIG. 4 is a block diagram illustrating a wireless device UE according to some embodiments of inventive concepts;

FIG. 5 is a block diagram illustrating a radio access network RAN node (e.g., a base station eNB/gNB) according to some embodiments of inventive concepts;

FIG. 6 is an illustration of an I-RNTI structure with a I-RNTI profile of 2 bits according to some embodiments of inventive concepts;

FIG. 7 is an illustration of a scenario for signaling of an I-RNTI profile and a Local RAN node Identifier according to some embodiments of inventive concepts;

FIGS. 8-17 are flow charts illustrating operations of a network node according to some embodiments of inventive concepts;

FIG. 18 is a block diagram of a wireless network in accordance with some embodiments;

FIG. 19 is a block diagram of a user equipment in accordance with some embodiments; and

FIG. 20 is a block diagram of a virtualization environment in accordance with some embodiments.

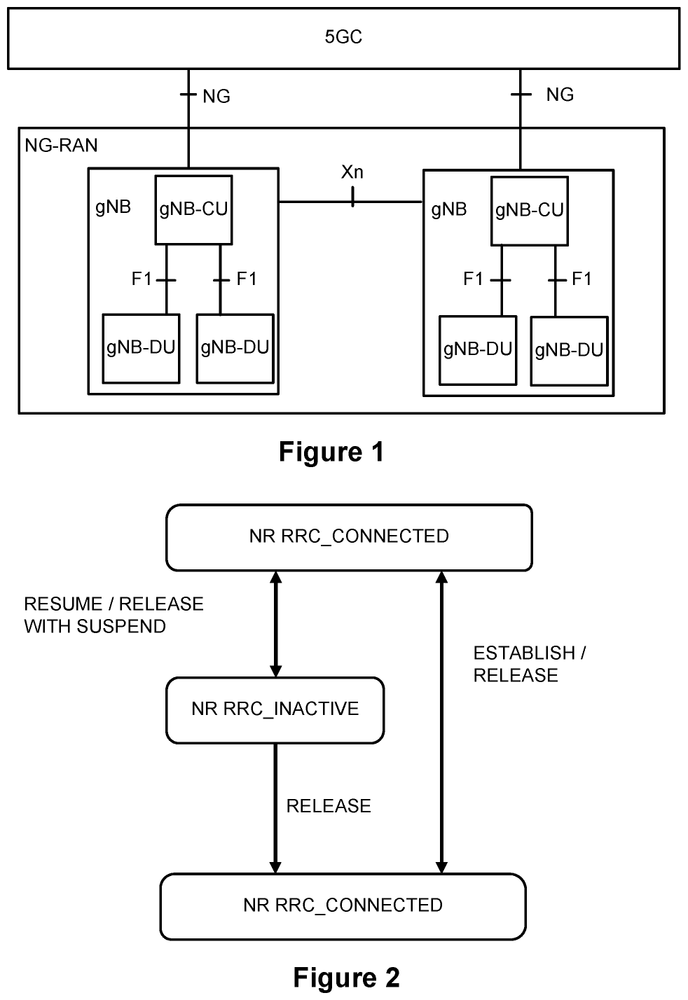

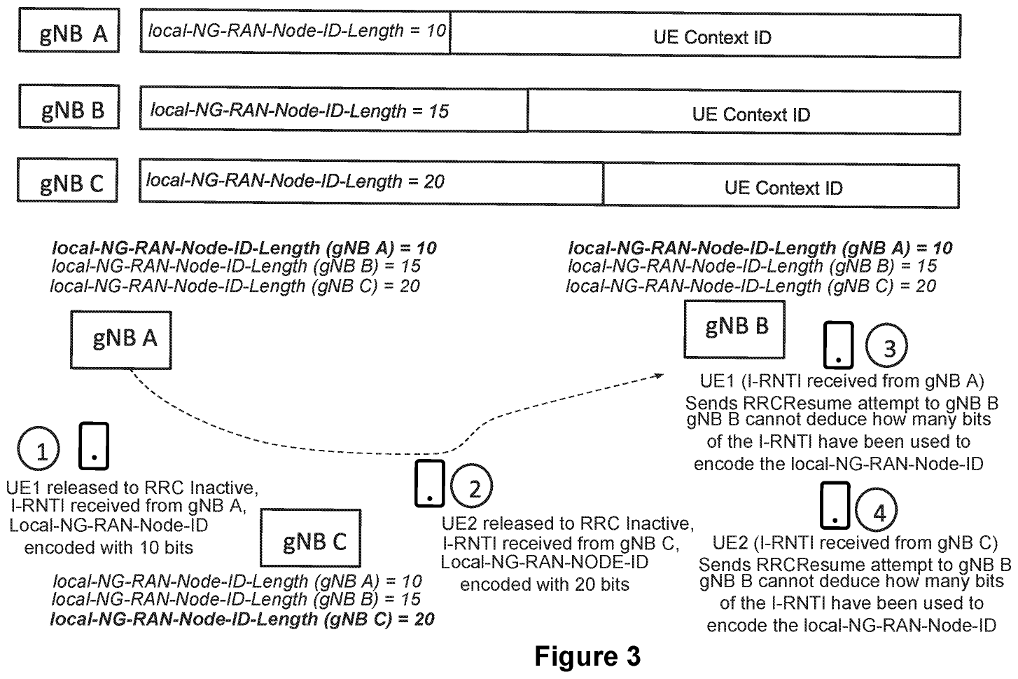

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

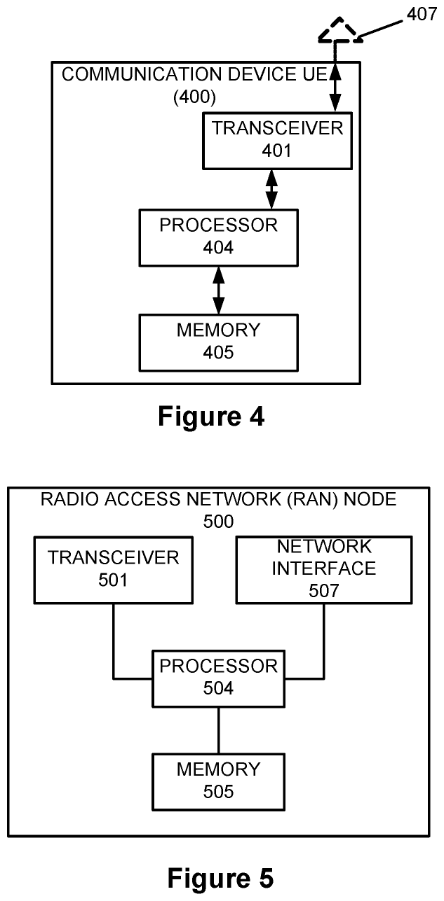

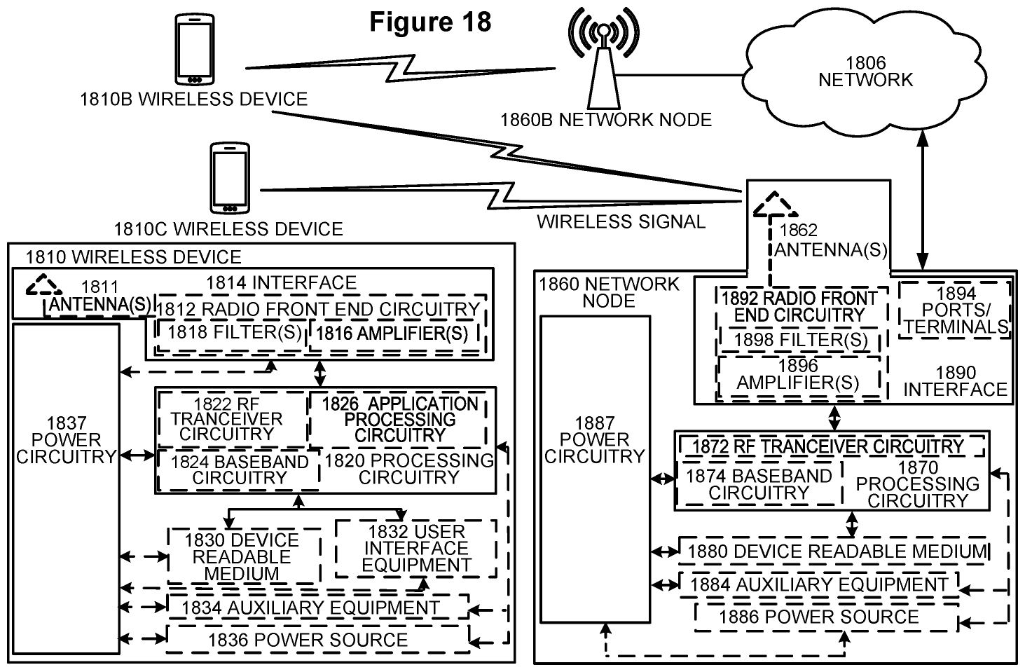

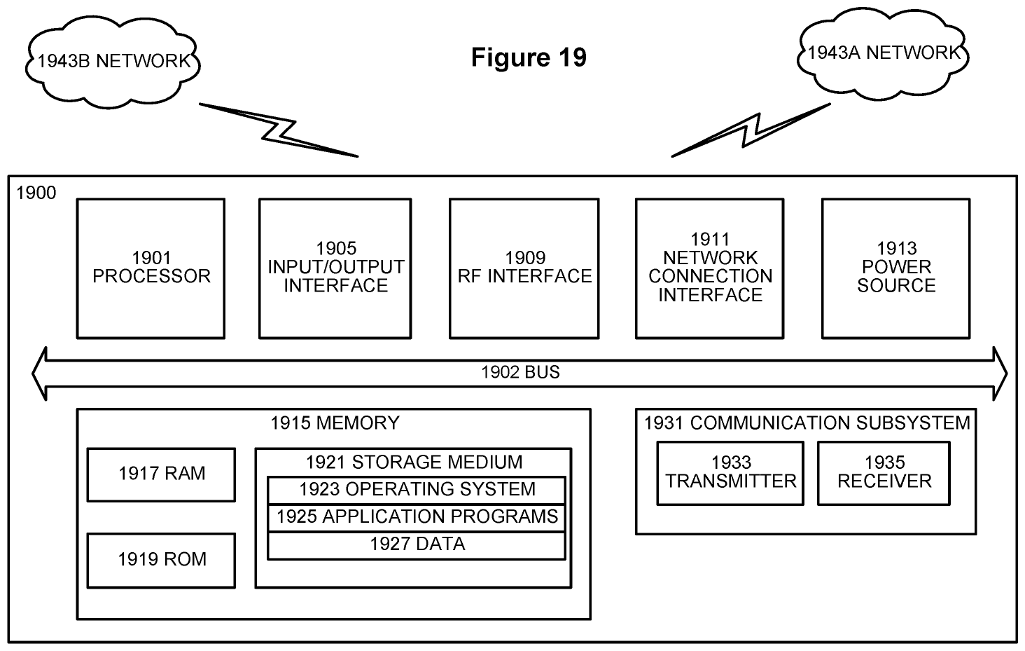

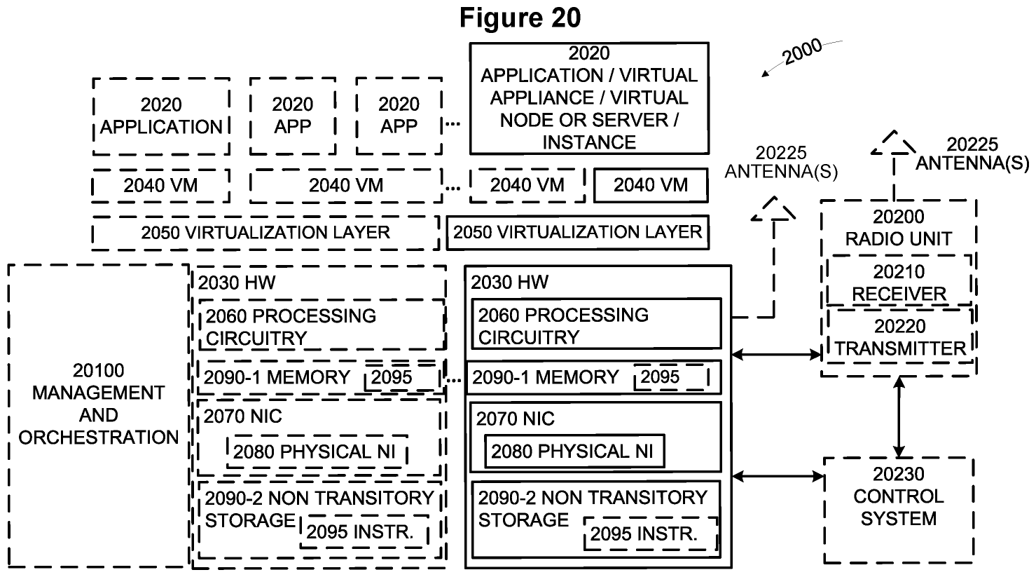

FIG. 4 is a block diagram illustrating elements of a communication device UE 400 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device 400 may be provided, for example, as discussed below with respect to wireless device 1810 of FIG. 18 UE 1900 of FIG. 19, virtualization hardware 2130 and virtual machine 2040 of FIG. 20, all of which should be considered interchangeable in the examples and embodiments described herein and be within the intended scope of this disclosure, unless otherwise noted.) As shown, communication device UE may include an antenna 407 (e.g., corresponding to antenna 1811 of FIG. 18 and/or antenna 20225 of FIG. 20), and transceiver circuitry 301 (also referred to as a transceiver, e.g., corresponding to interface 1814 of FIG. 18, interfaces 1905, 1909, 1911, transmitter 1933 and receiver 1935 of FIG. 19, and transmitter 20220 and receiver 20210 of FIG. 20) including a transmitter and a receiver configured to provide uplink and downlink radio communications with a base station(s) (e.g., corresponding to network node 1860 of FIG. 18, also referred to as a RAN node) of a radio access network. Communication device UE 400 may also include processing circuitry 403 (also referred to as a processor, e.g., corresponding to processing circuitry 1820 of FIG. 18, processor 1901 of FIG. 19, and processing circuitry 2060 of FIG. 20) coupled to the transceiver circuitry, and memory circuitry 405 (also referred to as memory, e.g., corresponding to device readable medium 1830 of FIG. 18 and or memory 2090 of FIG. 20) coupled to the processing circuitry. The memory circuitry 405 may include computer readable program code that when executed by the processing circuitry 403 causes the processing circuitry to perform operations according to embodiments disclosed herein. According to other embodiments, processing circuitry 403 may be defined to include memory so that separate memory circuitry is not required. Communication device UE may also include an interface (such as a user interface) coupled with processing circuitry 403, and/or communication device UE may be incorporated in a vehicle.

As discussed herein, operations of communication device UE may be performed by processing circuitry 403 and/or transceiver circuitry 401. For example, processing circuitry 303 may control transceiver circuitry 401 to transmit communications through transceiver circuitry 301 over a radio interface to a radio access network node (also referred to as a base station) and/or to receive communications through transceiver circuitry 401 from a RAN node over a radio interface. Moreover, modules may be stored in memory circuitry 405, and these modules may provide instructions so that when instructions of a module are executed by processing circuitry 403, processing circuitry 403 performs respective operations (e.g., operations discussed below with respect to Example Embodiments relating to wireless communication devices). According to some embodiments, a communication device UE 400 and/or an element(s)/function(s) thereof may be embodied as a virtual node/nodes and/or a virtual machine/machines.

FIG. 5 is a block diagram illustrating elements of a radio access network RAN node 500 (also referred to as a network node, base station, eNodeB/eNB, gNodeB/gNB, etc.) of a Radio Access Network (RAN) configured to provide cellular communication according to embodiments of inventive concepts. (RAN node 500 may be provided, for example, as discussed below with respect to network node 1860 of FIG. 18, and virtual hardware 2030 or virtual machine 2040 of FIG. 20, all of which should be considered interchangeable in the examples and embodiments described herein and be within the intended scope of this disclosure, unless otherwise noted.) As shown, the RAN node may include transceiver circuitry 501 (also referred to as a transceiver, e.g., corresponding to portions of interface 1890 of FIG. 18) including a transmitter and a receiver configured to provide uplink and downlink radio communications with mobile terminals. The RAN node may include network interface circuitry 507 (also referred to as a network interface, e.g., corresponding to portions of interface 1890 of FIG. 18 network and/or portions of interfaces 2070, 2080 of FIG. 20) configured to provide communications with other nodes (e.g., with other base stations) of the RAN and/or core network CN. The network node may also include processing circuitry 503 (also referred to as a processor, e.g., corresponding to processing circuitry 1870 of FIG. 18 and/or processing circuitry 2060 of FIG. 20) coupled to the transceiver circuitry, and memory circuitry 505 (also referred to as memory, e.g., corresponding to device readable medium 1880 of FIG. 18 and/or memory 2090 of FIG. 20) coupled to the processing circuitry. The memory circuitry 505 may include computer readable program code that when executed by the processing circuitry 503 causes the processing circuitry to perform operations according to embodiments disclosed herein. According to other embodiments, processing circuitry 503 may be defined to include memory so that a separate memory circuitry is not required.

As discussed herein, operations of the RAN node may be performed by processing circuitry 503, network interface 507, and/or transceiver 501. For example, processing circuitry 503 may control transceiver 501 to transmit downlink communications through transceiver 501 over a radio interface to one or more mobile terminals UEs and/or to receive uplink communications through transceiver 501 from one or more mobile terminals UEs over a radio interface. Similarly, processing circuitry 503 may control network interface 507 to transmit communications through network interface 507 to one or more other network nodes and/or to receive communications through network interface from one or more other network nodes. Moreover, modules may be stored in memory 505, and these modules may provide instructions so that when instructions of a module are executed by processing circuitry 503, processing circuitry 503 performs respective operations (e.g., operations discussed below with respect to Example Embodiments relating to RAN nodes). According to some embodiments, RAN node 500 and/or an element(s)/function(s) thereof may be embodied as a virtual node/nodes and/or a virtual machine/machines.

According to some other embodiments, a network node may be implemented as a core network CN node without a transceiver. In such embodiments, transmission to a wireless communication device UE may be initiated by the network node so that transmission to the wireless communication device UE is provided through a network node including a transceiver (e.g., through a base station or RAN node). According to embodiments where the network node is a RAN node including a transceiver, initiating transmission may include transmitting through the transceiver.

As previously indicated, an example of problematic situation is shown in FIG. 2 and is again described below.
1) Three gNBs use different values for the local-NG-RAN-Node-ID-Length, respectively: for “gNB A” local-NG-RAN-Node-ID-Length=10, for “gNB B” local-NG-RAN-Node-ID-Length=15, for “gNB C” local-NG-RAN-Node-ID-Length=20.
2) All the gNBs have full knowledge of the local-NG-RAN-Node-ID-Length of the other gNBs.
3) UE1 is released to RRC Inactive from “gNB A” and assigned an I-RNTI comprising a local-NG-RAN-Node-ID which is 10 bits long.
4) UE2 is released to RRC Inactive from “gNB C” and assigned an I-RNTI comprising a local-NG-RAN-Node-ID which is 20 bits long.
5) UE1 moves to a cell served by “gNB B” and attempts to resume. The “gNB B” receives the I-RNTI from UE1.
6) UE2 moves to a cell served by “gNB B” and attempts to resume. The “gNB B” receives the I-RNTI from UE2.
7) Without any further information available at the “gNB B”, the “gNB B” is not able to deduce if UE1 or UE2 received the I-RNTI from “gNB A” or from “gNB C” and with that it is not able to deduce how many most significant bits of the I-RNTI should be taken into account to derive the Local gNB ID identifying the RAN node from which the UE context needs to be retrieved.

Previous approaches have been described to address the disambiguation, from the I-RNTI, of the NG RAN node hosting the UE Context of an UE in RRC Inactive state.

In these previous approaches, the Local RAN Node Identifier is an identity of an NG-RAN node that is unique within a set of NG-RAN nodes that can interoperate over the XnAP, X2AP, NGAP or S1AP interface. The Local RAN Node Identifier is a sequence of X bits. If the Local RAN Node Identifier is of fixed length, it comprises a Local RAN Node ID of X bits. If the Local RAN Node Identifier is of variable length, it comprises a “Local RAN Node ID Length” of Y bits and a “Local RAN Node ID” of Z bits. A “Local RAN Node ID Length”, when used, means that Y bits are used to assess the amount of bits used for “Local RAN Node ID”. A “Local RAN Node ID” when used in combination to the use of “Local RAN Node ID Length”, occupies Z bits.

In these previous approaches, an NG-RAN node can build and maintain an association table, called Inactive Relation Table (IRT), the IRT table realizing an association between the PLMN RAN Node ID and the Local RAN Node Identifier, such that one PLMN RAN Node ID corresponds to one or more Local RAN Node Identifiers and one Local RAN Node Identifier corresponds to one PLMN RAN Node ID. The PLMN RAN Node ID is used to identify the network nodes such as gNBs where e.g. the gNB ID is defined in 3GPP TS 38.423 as a bit string of variable size, (22 . . . 32) bits long, equal to the leftmost bits of the NR Cell Identity IE contained in the NR CGI IE of each cell served by the source network node such as the first network node 111. The Local RAN Node Identifier is a shorter version (bitwise) of the PLMN RAN Node ID that fits into the identifier such as the I-RNTI.

In these previous solutions, there is no clear indication on how a Local RAN Node Identifier of variable length can be obtained. Namely, it is not possible to deduce the structure of the Local Node ID included in the I-RNTI. This creates a problem because without knowing the main structure of the I-RNTI there is the risk of misinterpreting the value of the Local Node ID. For example, there is the risk that the first Y+Z most significant bits of an I-RNTI (where Y and Z are the lengths of Local RAN Node ID Length and Local RAN Node ID as described above) are assumed to correspond to a node adopting a Local Node ID of fixed length. The fixed length Local Node ID of X bits derived would therefore be erroneous.

Another issue that can arise is related to scenarios where a high number of UE context identifiers is needed but where it is not possible to reduce the space of bits used to derive the Local Node IDs. For example, if a node is initially configured to use a Local Node ID of X bits, the number of I-RNTI bits that can be used to identify the UE context will be ((I-RNTI length)−X). If, at a later stage, the node is required to support a higher number of UEs, e.g. twice as many, the approach to follow with the solutions available so far is to increase the number of bits used for UE context identification, e.g. by 1 bit. The latter implies a reduction of the number of bits used for the Local Node ID, which implies a reduction by half of such overall number of Local Node IDs. This is a problem because the overall number of RAN nodes in the network may not allow such a big reduction of Local Node IDs.

In the description that follows, various embodiments of inventive concepts shall be described that are applicable to all RAT technologies where a temporary identifier like the I-RNTI can be assigned to a mobile device and where a RAN node identity needs to be derived from such identifier. For reasons of simplicity the methods are described with respect to the NR RAT. However the methods may apply also to other RATs such as LTE.

In some embodiments of inventive concepts, a standardized structure for the I-RNTI is introduced, so that it is possible for a RAN node receiving the I-RNTI at RRC Resume to disambiguate the RAN node hosting the UE Context of a UE in RRC Inactive state.

In these embodiments of inventive concepts, the gNBs belong to a certain category. This allows a standardized way to define flexible lengths in bits for the Local RAN node identifier (to disambiguate the RAN Node hosting the UE Context) and for the UE Context identifier.

In these embodiments of inventive concepts, a standardized structure of the I-RNTI is:
X number of bits to encode/decode a “I-RNTI profile”
Y number of bits to encode/decode a “Local RAN node Identifier”
Z number of bits to encode/decode a “UE Context Identifier”

The relation between X, Y, Z is:
For a full I-RNTI: X+Y+Z=40
For a short I-RNTI: X+Y+Z=24

In some embodiments, the length X in bits of a “I-RNTI profile” can be different for a full I-RNTI and a short I-RNTI.

In other embodiments, the length X in bits for one specific “I-RNTI profile” value associated to a full I-RNTI is the same for all the RAN nodes in the network.

In further embodiments, the length X in bits for one specific “I-RNTI profile” value associated to a short I-RNTI is the same for all the RAN nodes in the network.

In yet other embodiments, the length Y in bits of a “Local RAN node Identifier” for one specific “I-RNTI profile” value, associated to either a full I-RNTI or a short I-RNTI, is the same for all the RAN nodes in the network.

In yet further other embodiments, the length Z in bits of a “UE Context Identifier” for one specific “I-RNTI profile” value, associated to either a full I-RNTI or a short I-RNTI, is the same for all the RAN nodes in the network.

A “Local RAN node Identifier” is a number that can be determined locally by each RAN node, for example this can be a random number.

In some other embodiments of inventive concepts, a NG-RAN node may use more than one Local RAN Node ID (also called herein NG-RAN Node Address Index). This solution would address the issue of avoiding reduction of number of bits dedicated to the NG-RAN Node Address Index, for those scenarios where an increase of the number of identifiers used for UE context identification is needed. The number of bits assigned to describe the NG-RAN Node Address Index could then increase and the number of bits assigned to identify the UE context would then decrease.

The above embodiments of inventive concepts have the advantage to ease the identification of the RAN node hosting the UE Context of UEs in RRC Inactive state, particularly in network deployments where RAN nodes are provided by different network equipment vendors or RAN sharing is used between network operators. The solutions enable autonomous configuration of the I-RNTI which may also dynamically adapt to changes in the network

In the embodiments of inventive concepts described herein, a RAN node can be any of gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-RAN-CU (O-CU), O-CU-CP, O-CU-UP, O-DU, O-RU, or O-eNB.

### General Description of Various Embodiments where a NG RAN Node Uses One Local Node ID

The various embodiments of inventive concepts apply to both a “full I-RNTI” of 40 bits being used or a “short I-RNTI” of 24 bits is being used. In these various embodiments of inventive concepts, the I-RNTI structures includes the following parts:
1) a “I-RNTI profile”: all RAN nodes in the network use the same length in bits for this field. One length in bits can be used to encode a “full I-RNTI” and a different length in bits can be used to encode a “short I-RNTI”
2) a “Local RAN node identifier”, whose length in bits depends on the value of the “I-RNTI profile”
3) a “UE Context identifier”, whose length in bits depends on the value of the “I-RNTI profile”

### “I-RNTI Profile”

In the various embodiments of inventive concepts, the “I-RNTI profile” is a concept used to denote the structure of the I-RNTI. The value of a “I-RNTI profile” can be based on one of the following criteria:
Option 1: maximum number of UE Contexts for Inactive UEs that the RAN node can store
Option 2: number of cells served by the RAN node
Option 3: a combination of Option 1 and Option 2

Option 1 and Option 2 are described in further detail below.

Generally, a RAN node is assigned to one and only one “I-RNTI profile”.

The following description is provided for NR in some of the various embodiments of inventive concepts.

For NR, the gNB ID can be a bit string of size between 22 and 32 bits and it is equal to leftmost bits of the NR Cell Identity information element (IE) contained in the NR CGI IE (new radio cell global identification information element) of each cell served by the gNB. The NR CGI IE is a bit string of 36 bits.

In NR, the length of a gNB ID can be one of the following (11 values): 22, 23, 24, 25, 26, 27, 28, 29, 30, 31, 32.

Considering the length of 36 bits of the NR CGI, and the variable length in bits (from 22 to 32) of the gNB ID, the number of bits of the NR CGI that can be used to identify a cell can be one of the following (11 values): 4, 5, 6, 7, 8, 9, 10, 11, 12, 13, 14.

Based on the number of bits of the NR CGI that can be used to identify a cell, the minimum number of cells that a RAN node can serve is one of the following values: 1, 17, 33, 65, 129, 257, 513, 1025, 2049, 4097, 8193.

Based on the number of bits of the NR CGI that can be used to identify a cell, the maximum number of cells that a RAN node can serve is one of the following values: 16, 32, 64, 128, 256, 512, 1024, 2048, 4096, 8192, 16384.

Option 1: “I-RNTI Profile” Based on the Maximum Number of UE Contexts for Inactive UEs that the RAN Node can Store

In these embodiments of inventive concepts, the maximum number of possible “I-RNTI profiles” is given by the maximum number of distinct lengths in bits of the UE Context Identifier.

The maximum number of distinct lengths in bits of the UE context identifier depends on the number of bits in length of the I-RNTI, i.e.:
For a full I-RNTI, the UE Context Identifier can be encoded/decoded with a maximum of 39 bits. The maximum number of possible “I-RNTI profile es” is 39 and 6 bits are needed to uniquely identify all of them
For a short I-RNTI, the UE Context Identifier can be encoded/decoded with a maximum of 23 bits. The maximum number of possible “I-RNTI profile” is 23 and 5 bits are needed to uniquely identify all of them

For the case of full I-RNTI, the “I-RNTI profiles” can be numbered sequentially, e.g. with a I-RNTI profile “N” increasing with the increase in the maximum number of stored UE Context.
I-RNTI profile N: gNBs with maximum number of stored UE Contexts=2\hat{ }N where N is a number included in the range [0 . . . 39]

Similarly, for the case of short I-RNTI, the “I-RNTI profile” can be numbered sequentially, e.g. with a I-RNTI profile “M” increasing with the increase in the maximum number of stored UE Context.
I-RNTI profile M: gNBs with maximum number of stored UE Contexts=2\hat{ }M where M is a number included in the range [0 . . . 23]

The actual number of “I-RNTI profiles” can be reduced compared to the maximum if some grouping is done, i.e. only considering a subset of the values 2\hat{ }N with N described above. This allows a reduction in the number of bits needed to encode/decode a “I-RNTI profile” value.

An example with 4 “I-RNTI profiles” is illustrated below. The corresponding number of bits needed to encode a “I-RNTI profile” is 2.
I-RNTI profile 0: gNBs with maximum number of stored UE Contexts=2\hat{ }16 (65536)
I-RNTI profile 1: gNBs with maximum number of stored UE Contexts=2\hat{ }20 (1048576)
I-RNTI profile 2: gNBs with maximum number of stored UE Contexts=2\hat{ }23 (8388608)
I-RNTI profile 3: gNBs with maximum number of stored UE Contexts=2\hat{ }26 (67108864)

### Option 2: “I-RNTI Profile” Based on the Number of Cells Served by the RAN Node

In these embodiments of inventive concepts, the maximum number of “I-RNTI profiles” is given by the maximum number of distinct lengths in bits of the gNB ID part of the Global gNB ID, or the by the maximum number of distinct lengths in bits of the ng-eNB ID part of the Global ng-eNB ID, as defined in 3GPP TS 38.423.

For an NG-RAN comprising of gNBs, the maximum number of “I-RNTI profiles” is 11. To uniquely identify all the possible “I-RNTI profiles”, 4 bits are required. A non-limiting example of “I-RNTI profiles” is:
“I-RNTI profile”=“0000”: gNBs serving a number of cells in the range [1 to 16]
“I-RNTI profile”=“0001”: gNBs serving a number of cells in the range [17 to 32]
“I-RNTI profile”=“0010”: gNBs serving a number of cells in the range [33 to 64]
“I-RNTI profile”=“0011”: gNBs serving a number of cells in the range [65 to 128]
“I-RNTI profile”=“0100”: gNBs serving a number of cells in the range [129 to 256]
“I-RNTI profile”=“0101”: gNBs serving a number of cells in the range [257 to 512]
“I-RNTI profile”=“0110”: gNBs serving a number of cells in the range [513 to 1024]
“I-RNTI profile”=“0111”: gNBs serving a number of cells in the range [1025 to 2048]
“I-RNTI profile”=“1000”: gNBs serving a number of cells in the range [2049 to 4096]
“I-RNTI profile”=“1001”: gNBs serving a number of cells in the range [4097 to 8192]
“I-RNTI profile”=“1010”: gNBs serving a number of cells in the range [8193 to 16384]

The number of “I-RNTI profiles” can be reduced if some grouping is done. An example is provided below, with 4 “I-RNTI profiles”, instead of 11. The corresponding number of bits required to encode/decode a “I-RNTI profile” value is 2.
“I-RNTI profile”=“00”: gNBs serving a number of cells in the range [1 to 64]
“I-RNTI profile”=“01”: gNBs serving a number of cells in the range [65 to 512]
“I-RNTI profile”=“10”: gNBs serving a number of cells in the range [513 to 4096]
“I-RNTI profile”=“11”: gNBs serving a number of cells in the range [4097 to 16384]

The value of “I-RNTI profile” identifies the RAN nodes that can serve a number of cells included in a closed range expressed as:
a) [2\hat{ }(gNB ID Length Min), 2\hat{ }(gNB ID Length Max)] if “gNB ID Length Min” value is 0
b) [2\hat{ }(gNB ID Length Min)+1, 2\hat{ }(gNB ID Length Max)] if “gNB ID Length Min” value is one of 4, 5, 6, 7, 8, 9, 10, 11, 12, 13

where the following conditions apply:
“gNB ID Length Min” is one of the values: 0, 4, 5, 6, 7, 8, 9, 10, 11, 12, 13
“gNB ID Length Max” is one of the values: 4, 5, 6, 7, 8, 9, 10, 11, 12, 13, 14
for a given “I-RNTI profile”, the “gNB ID Length Min” is strictly smaller than “gNB ID Length Max”
all the possible lengths of the gNB ID shall be considered
if more than one value of “I-RNTI profile” are defined, different values of I-RNTI profile” shall be mapped to different values of “gNB ID Length Min” and “gNB ID Length Max”

Two examples to clarify are illustrated, with a “I-RNTI profile” encoded with 2 bits:
1) If “I-RNTI profile”=“00” for “gNB ID Length Min”=0 and “gNB ID Length Max”=4, the “I-RNTI profile”=“00” identifies all the RAN nodes that can serve a number of cells included in the range from 1 to 16
2) If “I-RNTI profile”=“00” for “gNB ID Length Min”=0 and “gNB ID Length Max”=6, the “I-RNTI profile”=“00” identifies all the RAN nodes that can serve a number of cells included in the range from 1 to 64

### “Local RAN Node Identifier” and “UE Context Identifier”

In some other embodiments of inventive concepts:
the “Local RAN node identifier” field of the I-RNTI is used for the disambiguation of the identity of the RAN node hosting the UE Context for a UE in RRC Inactive state
the “UE Context identifier” field of the I-RNTI is used to uniquely identify the UE Context of a UE in RRC Inactive state.

For a given value of “I-RNTI profile”, whose length in bit is X:
The length Y in bits of the “Local RAN node identifier” is the same for all RAN nodes throughout the network
The length Z in bits of the “UE Context identifier” is the same for all RAN nodes throughout the network

The length X in bits of “I-RNTI profile” value to be used for full I-RNTI (or short I-RNTI) is common for all the RAN nodes in a network.

Different combinations of Y and Z can satisfy the conditions:
If I-RNTI length is 40 bits (full I-RNTI): X+Y+Z=40
If I-RNTI length is 24 bits (full I-RNTI): X+Y+Z=24

To guarantee interoperability in network scenarios, for a given value of “I-RNTI profile” valid for full I-RNTI (or short I-RNTI), the same combination of values Y and Z can be used throughout the network.

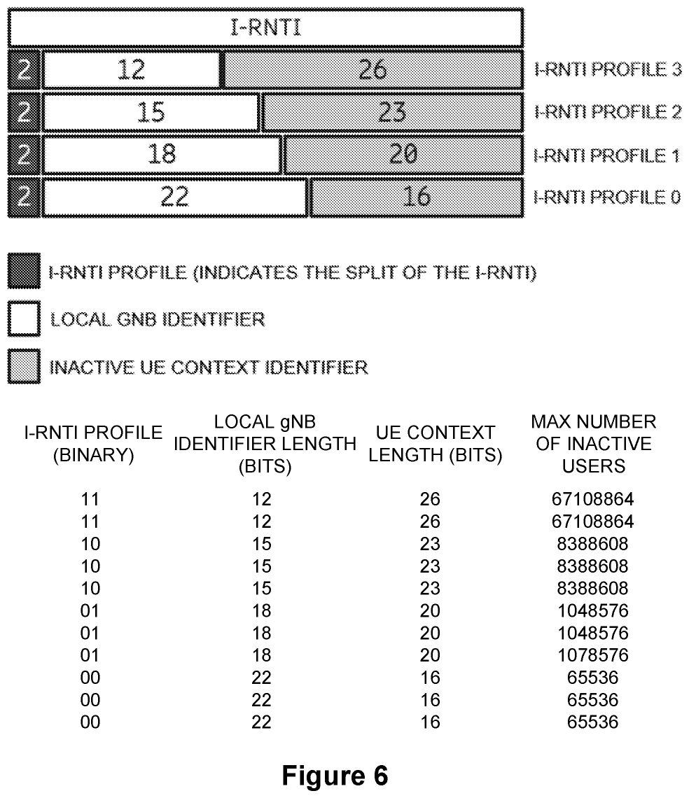

An example is shown in FIG. 6, where the I-RNTI is a full I-RNTI. The “I-RNTI profile” length is 2 bits and the split between the remaining 38 bits of I-RNTI is as follows:
“I-RNTI profile”=“00”: 22 bits for Local gNB Identifier and 16 bits for the UE context identifier;
“I-RNTI profile”=“01”: 18 bits for Local gNB Identifier and 20 bits for the UE context identifier;
“I-RNTI profile”=“10”: 15 bits for Local gNB Identifier and 23 bits for the UE context identifier;
“I-RNTI profile”=“11”: 12 bits for Local gNB Identifier and 26 bits for the UE context identifier;

In some embodiments of inventive concepts, the number of I-RNTI profiles could be 0. In this case there is no need for a bit to represent the I-RNTI profile and the overall I-RNTI structure will consist of two fields, with a maximum number of Inactive users common for all RAN nodes.

### Signalling of “I-RNTI Profile” and “Local Node RAN Identifier”

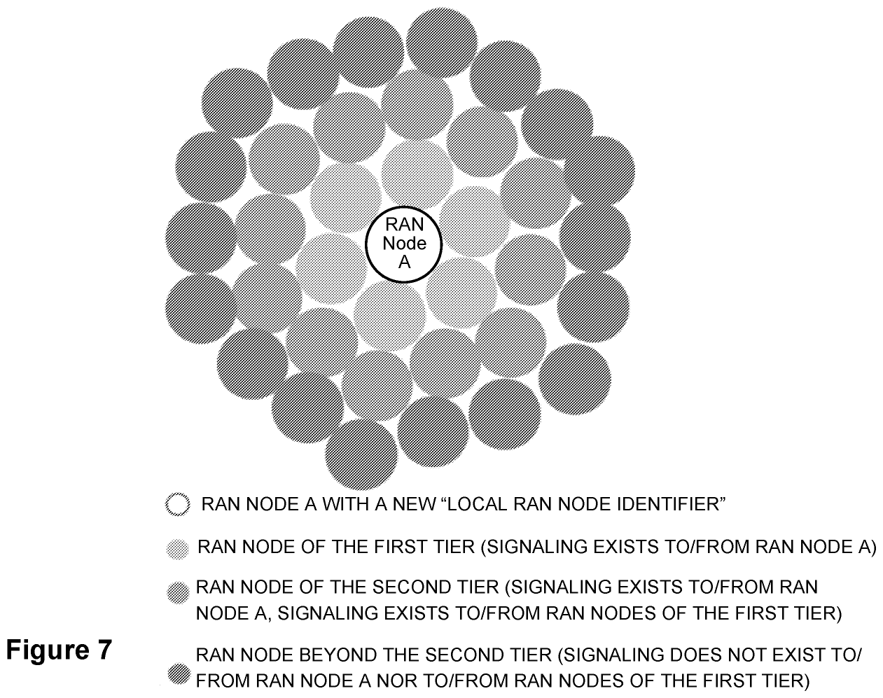

The information regarding the “I-RNTI profile” and the “Local RAN node Identifier” is signalled between neighbouring RAN nodes i.e. RAN nodes with a signalling connection available between them (e.g. directly via XnAP or indirectly via NGAP). In the example shown in FIG. 7, “RAN Node A” sends the “I-RNTI profile” and the “Local RAN node Identifier” associated to “RAN Node A” to the RAN nodes of the first tier, via XnAP signalling.

A RAN node also receives from its neighbouring RAN nodes, the “I-RNTI profile” and the “Local RAN node Identifier” of RAN nodes of the second tier, i.e. RAN nodes neighbouring the RAN nodes of the first tier.

### Change of “I-RNTI Profile”

In network developments, a RAN node may be initially deployed to serve a certain maximum number of UE Contexts for Inactive UE or a number of cells, and later expanded to serve more Inactive UEs or more cells. The opposite case is also possible where the maximum number of Inactive UEs to be served or the number of served cells is reduced.

If the change is such that the RAN node should be assigned to a different I-RNTI profile, the “I-RNTI profile” and the “Local RAN node Identifier” of the RAN node can be changed and the neighbouring RAN nodes informed accordingly.

The occurrence of such event normally happens over a large time period (at least hours, if not days or months), but it can be possible for a RAN node, at least for a configurable transient period, to use both the “I-RNTI profile” and the “Local RAN node Identifier” preceding the change and the “I-RNTI profile” and “Local RAN node Identifier” after the change.

Similarly, a RAN node, receiving from a neighbouring RAN node the information that a new “I-RNTI profile” and a new “Local RAN node Identifier” are used by the neighbouring RAN node, can be configured to use, during a transient period, both the “I-RNTI profile” and the “Local RAN node Identifier” assigned by the neighbouring RAN node prior to the change and the “I-RNTI profile” and “Local RAN node Identifier” assigned by neighbouring RAN node after the change.

During the transient period, the disambiguation of the gNB ID from received I-RNTIs can be done according to both the old and the new values of “I-RNTI profile” and “Local RAN node Identifier” of the neighbouring RAN node.

### Handling of Conflicts

If a conflict is detected, a RAN node can derive a new “Local RAN node Identifier” and it may inform the neighbouring RAN node of the new value. It should be noted that the RAN node may also decide not to re-derive a new Local RAN node Identifier and therefore accept that there is a Local RAN Node Identifier conflict that will generate possibly wrong requests of UE context fetching for UEs moving from RRC_INACTIVE to RRC_CONNECTED.

### Embodiments Related to I-RNTI Structure

In some embodiments of inventive concepts, the I-RNTI structure is realized as follows:
X number of bits to encode/decode a “I-RNTI profile”
   In some embodiments of inventive concepts, the length X in bits used to encode/decode a “I-RNTI profile” value valid for a full I-RNTI is the same for all the RAN nodes in the network
   In further embodiments of inventive concepts, the length X in bits used to encode/decode a “I-RNTI profile” value valid for a short I-RNTI is the same for all the RAN nodes in the network
   In other embodiments of inventive concepts, the length in bits used to encode/decode a “I-RNTI profile” value valid for a full I-RNTI AND the length in bits used to encode/decode a “I-RNTI profile” value valid for a short I-RNTI can be the same or different
Y number of bits to encode/decode a “Local RAN node Identifier”
   In some embodiments of inventive concepts, the length Y in bits used to encode/decode a “Local RAN node Identifier” valid for one specific “I-RNTI profile” value valid for a full I-RNTI is the same for all the RAN nodes in the network
   In other embodiments of inventive concepts, the length Y in bits used to encode/decode a “Local RAN node Identifier” valid for one specific “I-RNTI profile” value valid for a short I-RNTI is the same for all the RAN nodes in the network
   In yet other embodiments of inventive concepts, the length in bits used to encode/decode a “Local RAN node Identifier” value valid for one specific “I-RNTI profile” value valid for a full I-RNTI AND the length in bits used to encode/decode a “Local RAN node Identifier” value valid for one specific “I-RNTI profile” value valid for a short I-RNTI can be the same or different
Z number of bits to encode/decode a “UE Context Identifier”
   In some embodiments of inventive concepts, the length Z in bits used to encode/decode a “UE Context Identifier” valid for one specific “I-RNTI profile” value valid for a full I-RNTI is the same for all the RAN nodes in the network
   In other embodiments of inventive concepts, the length Z in bits used to encode/decode a “UE Context Identifier” valid for one specific “I-RNTI profile” value valid for a short I-RNTI is the same for all the RAN nodes in the network
   In further embodiments of inventive concepts, the length in bits used to encode/decode a “UE Context Identifier” value valid for one specific “I-RNTI profile” value valid for a full I-RNTI AND the length in bits used to encode/decode a “UE Context Identifier” value valid for one specific “I-RNTI profile” value valid for a short I-RNTI can be the same or different

The following conditions apply:
for a full I-RNTI: X+Y+Z=40
for a short I-RNTI: X+Y+Z=24

### I-RNTI Profile

In one embodiment of inventive concepts, a list of one or more admissible “I-RNTI profile” values valid for a full I-RNTI is preconfigured (fixed), and the list is the same for all the RAN nodes in the network.

In another embodiment of inventive concepts, a list of one or more admissible “I-RNTI profile” values valid for a short I-RNTI is preconfigured (fixed), and the list is the same for all the RAN nodes in the network.

In yet another embodiment of inventive concepts, a list of one or more admissible “I-RNTI profile” values valid for a full I-RNTI is/are configured and the list is the same for all the RAN nodes in the network.

In another embodiment, a list of one or more “I-RNTI profile” values valid for a short I-RNTI are configured and the list is the same for all the RAN nodes in the network.

### UE Context Identifier

In one embodiment of inventive concepts, the length Z in bits to encode/decode the “UE Context Identifier” for the full I-RNTI (or for the short I-RNTI) and for a given “I-RNTI profile” value to be used with full I-RNTI (or with the short I-RNTI), is preconfigured (i.e., fixed) and it is the same for all RAN nodes in the network.

In other embodiments of inventive concepts, the length Z in bits to encode/decode the “UE Context Identifier” for the full I-RNTI (or for the short I-RNTI) and for a given “I-RNTI profile” value to be used with full I-RNTI (or with the short I-RNTI), is configured per RAN node and it is the same for all RAN nodes in the network.

In a further embodiment of inventive concepts, the value Z_MAX is defined as the “maximum number of UE Contexts for Inactive UEs that a RAN node can store” and when the length in bits used to encode the “UE Context” is Z its maximum value is 2\hat{ }Z

In another embodiment of inventive concepts, the value Z_MAX valid for the full I-RNTI (or the short I-RNTI) and for a given “I-RNTI profile” value valid for the full I-RNTI (or the short I-RNTI) is preconfigured (fixed) and it is the same for all RAN nodes in the network.

In yet another embodiment of inventive concepts, the value Z_MAX valid for the full I-RNTI (or the short I-RNTI) and for a given “I-RNTI profile” value valid for the full I-RNTI (or the short I-RNTI) is configured per RAN node and it is the same for all RAN nodes in the network.

The value Z_MAX valid for the full I-RNTI and for a given “I-RNTI profile” value valid for the full I-RNTI AND the value Z_MAX valid for the short I-RNTI and for a given “I-RNTI profile” value valid for the short I-RNTI can be the same or different.

### Local RAN Node Identifier

In one embodiment of inventive concepts, the length Y in bits used to encode/decode the “Local RAN node Identifier” for a given “I-RNTI profile” value valid for the full I-RNTI (or the short I-RNTI) is preconfigured (fixed) and it is the same for all RAN nodes in the network.

In another embodiment of inventive concepts, the length Y in bits used to encode/decode the “Local RAN node Identifier” for a given “I-RNTI profile” value valid for the full I-RNTI (or the short I-RNTI) is configured per RAN node and it is the same for all RAN nodes in the network.

The length Y in bits used to encode/decode the “Local RAN node Identifier” for a given “I-RNTI profile” value valid for the full I-RNTI AND the length Y in bits used to encode/decode the “Local RAN node Identifier” for a given “I-RNTI profile” value valid for the short I-RNTI can be the same or different.

### Range of Cells Served by a RAN Node

In one embodiment of inventive concepts, the values CELL MIN and CELL_MAX are defined respectively as the “minimum number of cells” and “maxim number of cells” that a RAN node can serve when associated to a given “I-RNTI profile” value valid for the full I-RNTI (or the short I-RNTI).

In another embodiment of inventive concepts, the values CELL MIN and CELL_MAX valid for the full I-RNTI (or the short I-RNTI) and for a given “I-RNTI profile” value valid for the full I-RNTI (or the short I-RNTI) are preconfigured (fixed) and the same for all RAN nodes in the network.

In yet other embodiments of inventive concepts, the values CELL MIN and CELL_MAX valid for the full I-RNTI (or the short I-RNTI) and for a given “I-RNTI profile” value valid for the full I-RNTI (or the short I-RNTI) are configured per RAN node and the same for all RAN nodes in the network.

The values CELL MIN and CELL_MAX valid for the full I-RNTI and for a given “I-RNTI profile” value valid for the full I-RNTI AND the values CELL MIN and CELL_MAX valid for the short I-RNTI and for a given “I-RNTI profile” value valid for the short I-RNTI can be the same or different.

### Embodiments Related to First RAN Node

### I-RNTI Profile

In one embodiment of inventive concepts, the first RAN node is associated with only one of the admissible “I-RNTI profile” value to be used for the full I-RNTI and with only one of the admissible “I-RNTI profile” value to be used for the short I-RNTI.
the “I-RNTI profile” value to be used for the full I-RNTI and the “I-RNTI profile” value to be used for the short I-RNTI can be the same or different

In another embodiment of inventive concepts, the “I-RNTI profile” value to which the first RAN node is associated with, separately for the full I-RNTI and/or for the short I-RNTI, is obtained based on:
the number Z_MAX
the values CELL MIN and CELL_MAX
a combination of the previous options

### Local RAN Node Identifier and UE Context Identifier

The length Y in bits the first RAN Node uses to encode/decode a “Local RAN node Identifier” and the length Z in bits to encode/decode the “UE Context Identifier” can be obtained in one of the following options:
Option 1:
   the length Y in bits of the “Local RAN node Identifier” for a given “I-RNTI profile” value valid for the full I-RNTI (or for the short I-RNTI) is preconfigured (fixed)
   the length Z in bits of the “UE Context Identifier” for a given “I-RNTI profile” value valid for the full I-RNTI (or for the short I-RNTI) is preconfigured (fixed)
Option 2:
   in one variant, the length Y in bits of the “Local RAN node Identifier” for a given “I-RNTI profile” value valid for the full I-RNTI (or for the short I-RNTI) is preconfigured (fixed)
   in one variant, the length Y in bits of the “Local RAN node Identifier” (fixed) for a given “I-RNTI profile” value valid for the full I-RNTI (or for the short I-RNTI) is configured
   the length Z in bits the first RAN Node uses to encode/decode a “UE Context Identifier” is given by:
      for a full I-RNTI: Z=40−X−Y
      for a short I-RNTI: Z=24−X−Y
Option 3:
   in one variant of inventive concepts, the length Z in bits of the “UE Context Identifier” for a given “I-RNTI profile” value valid for the full I-RNTI (or for the short I-RNTI) is preconfigured (fixed)
   in one variant of inventive concepts, the length Z in bits of the “UE Context Identifier” for a given “I-RNTI profile” value valid for the full I-RNTI (or for the short I-RNTI) is configured
   the length Y in bits the first RAN Node uses to encode/decode a “Local RAN node Identifier” is given by:
      for a full I-RNTI: Y=40−X−Z
      for a short I-RNTI: Y=24−X−Z

In another embodiment of inventive concepts, the first RAN node selects a “Local RAN node Identifier” as a random number.

In another embodiment of inventive concepts, the first RAN node, sends to a second RAN node, neighboring the first RAN node, via a Setup procedure (e.g. Xn Setup procedure) or a via a RAN Configuration Update (e.g. NG-RAN node Configuration Update procedure), one or more of the following:
the “I-RNTI profile” valid for the first RAN node and associated with the full I-RNTI
the “I-RNTI profile” valid for the first RAN node and associated with the short I-RNTI
the “Local node RAN Identifier” valid for the first RAN node and associated with the full I-RNTI
the “Local node RAN Identifier” valid for the first RAN node and associated with the short I-RNTI
the “I-RNTI profile” valid for a third RAN node and associated with the full I-RNTI, the “I-RNTI profile” valid for a third RAN node and associated with the short I-RNTI, the “Local node RAN Identifiers” valid for a third RAN node and associated with the full I-RNTI, the “Local node RAN Identifiers” valid for a third RAN node and associated with the short I-RNTI
   the third RAN node neighboring the first RAN node and the third RAN node neighboring or not neighboring the second RAN node

In another embodiment of inventive concepts, the first RAN node receives from the second RAN node, neighboring the first RAN node, via a Setup procedure (e.g. Xn Setup procedure) or a via a RAN Configuration Update (e.g. NG-RAN node Configuration Update procedure), one or more of the following:
the “I-RNTI profile” valid for the second RAN node and associated with the full I-RNTI
the “I-RNTI profile” valid for the second RAN node and associated with the short I-RNTI
the “Local node RAN Identifier” valid for the second RAN node and associated with the full I-RNTI
the “Local node RAN Identifier” valid for the second RAN node and associated with the short I-RNTI
the “I-RNTI profile” valid for a fourth RAN node and associated with the full I-RNTI, the “I-RNTI profile” valid for a fourth RAN node and associated with the short I-RNTI, the “Local node RAN Identifiers” valid for a fourth RAN node and associated with the full I-RNTI, the “Local node RAN Identifiers” valid for a fourth RAN node and associated with the short I-RNTI
   the fourth RAN node neighboring the second RAN node and the fourth RAN node neighboring or not neighboring the first RAN node
if the first RAN node detects that more than one Global NG-RAN Node ID match the received “Local RAN node Identifier” a conflict is detected, and the first RAN node informs the second RAN node of a conflict
the first RAN node sends an RRC Release message with suspend configuration to transition a UE to RRC Inactive comprising an I-RNTI (either a full I-RNTI or a short I-RNTI)
   the I-RNTI comprising a “I-RNTI profile”, a “Local RAN node Identifier” and a “UE Context Identifier”

In another embodiment of inventive concepts, the first RAN node can derive a new “Local RAN node Identifier” and sends the new “Local RAN node Identifier” to the second RAN node via a RAN Configuration Update procedure
the new “Local RAN node Identifier” is derived if a conflict is detected or the “I-RNTI profile” is changed.

### Embodiments at the Second RAN Node

The second RAN node:
receives from the first RAN node, neighboring the second RAN node, via a Setup procedure (e.g. Xn Setup procedure) or a via a RAN Configuration Update (e.g. NG-RAN node Configuration Update procedure), one or more of the following:
   the “I-RNTI profile” valid for the first RAN node and associated with the full I-RNTI
   the “I-RNTI profile” valid for the first RAN node and associated with the short I-RNTI
   the “Local node RAN Identifier” valid for the first RAN node and associated with the full I-RNTI
   the “Local node RAN Identifier” valid for the first RAN node and associated with the short I-RNTI
   the “I-RNTI profile” valid for a third RAN node and associated with the full I-RNTI, the “I-RNTI profile” valid for a third RAN node and associated with the short I-RNTI, the “Local node RAN Identifiers” valid for a third RAN node and associated with the full I-RNTI, the “Local node RAN Identifiers” valid for a third RAN node and associated with the short I-RNTI
      the third RAN node neighboring the first RAN node and the third RAN node neighboring or not neighboring the second RAN node
   if the second RAN node detects that more than one Global NG-RAN Node ID match the received “Local RAN node Identifier” a conflict is detected, and the second RAN node informs the first RAN node of a conflict
sends to the first RAN node, neighboring the second RAN node, via a Setup procedure (e.g. Xn Setup procedure) or a via a RAN Configuration Update (e.g. NG-RAN node Configuration Update procedure), one or more of the following:
   the “I-RNTI profile” valid for the second RAN node and associated with the full I-RNTI
   the “I-RNTI profile” valid for the second RAN node and associated with the short I-RNTI
   the “Local node RAN Identifier” valid for the second RAN node and associated with the full I-RNTI
   the “Local node RAN Identifier” valid for the second RAN node and associated with the short I-RNTI
   the “I-RNTI profile” valid for a fourth RAN node and associated with the full I-RNTI, the “I-RNTI profile” valid for a fourth RAN node and associated with the short I-RNTI, the “Local node RAN Identifiers” valid for a fourth RAN node and associated with the full I-RNTI, the “Local node RAN Identifiers” valid for a fourth RAN node and associated with the short I-RNTI
      the fourth RAN node neighboring the second RAN node and the fourth RAN node neighboring or not neighboring the first RAN node
receives an RRC Resume Request/RRC Resume Request 1 (or alike) to transition a UE from RRC Inactive to RRC Connected, comprising an I-RNTI (either a full I-RNTI or a short I-RNTI) which comprises a “I-RNTI profile” a “Local RAN node Identifier” and a “UE Context Identifier”
reads the “I-RNTI profile” and deduces the length in bits of the “Local RAN node Identifier” of the first RAN node and the length in bits of the “UE Context Identifier” corresponding to the received type of I-RNTI (full I-RNTI or short I-RNTI)
extracts the “Local RAN node Identifier” of the first RAN node comprised in the received I-RNTI
compares the “Local RAN node Identifier” of the first RAN node comprised in the received I-RNTI with the “Local RAN node Identifier” received from the first RAN node
disambiguate the gNB ID part of the Global gNB ID (or the ng-eNB ID part of the Global ng-eNB ID)
if the second RAN node detects that more than one Global NG-RAN Node ID match the “Local RAN node Identifier” a conflict is detected, and the second RAN node informs the first RAN node of a conflict

In another embodiment, the second RAN node can draw a new “Local RAN node Identifier” and sends the new “Local RAN node Identifier” to the first RAN node via a RAN Configuration Update procedure
the new “Local RAN node Identifier” is derived if a conflict is detected or the “I-RNTI profile” is changed.

### General Description of Various Embodiments where a NG RAN Node Uses More than One Local Node ID

These embodiments of inventive concepts enable the NG-RAN Node Address Index (also known in the methods description above as Local Node Identifier) to be automatically configured in a network. These embodiments are applicable both for the 24-bit I-RNTI and the 40-bit I-RNTI. The general idea is that more than one NG-RAN Node Address Index can be assigned to one NG-RAN Node.

Each NG-RAN Node may be associated with a number of NG-RAN Node Address Indexes and the capacity of an NG-RAN Node is scaled up by assigning more NG-RAN Node Address Indexes to it. For example, assume that 30 bits in a 40 bit I-RNTI are assigned to the NG-RAN Address Index which leaves 10 bits for the node. These 10 bits are sufficient to identify the UE contexts of up to 1024 nodes, which is a number of UE contexts typically associated to a small scale RAN node. For RAN nodes of larger scale, such as a macro node or a data center RAN implementation, a much higher number of UE contexts are handled and would need to be identified via the I-RNTI. For such larger nodes, more NG-RAN Address Indexes are allocated. A node which needs to be able to assign, e.g. more than 200,000 RRC Inactive UEs would need 256 NG-RAN Node Address Indexes. In the extreme case, the complete I-RNTI can be allocated to the NG-RAN Node Address Indexes (40 bits or 24 bits depending on the I-RNTI type), which means that one NG-RAN Node Address Index is associated to only one UE Context.

In one embodiment of inventive concepts, the number of bits that can be selected to a NG-RAN Address Index can be preconfigured (e.g. 30 bits for full I-RNTI, 16 for the short I-RNTI), and common for all NG-RAN nodes throughout the network.

In another embodiment of inventive concepts, the number of bits that can be selected to a NG-RAN Address Index can be configured per NG-RAN node.

Some advantages that may be achieved include:
The number of available NG-RAN Node Address Indexes becomes larger (in this example 2\hat{ }30=2 000 000 000).
The difference between large and small nodes becomes smaller in the sense that an NG-RAN Node Address Index taken into use by a data center deployment would serve the same order of UEs as a NG-RAN Node Address Index taken into use by a smaller node.
The geographical coverage area for a NG-RAN Node Address Index may become smaller if a large node allocates NG-RAN Node Address Indices taking for example which DU releases the UE to RRC Inactive state. This could reduce the probability for conflicts with neighboring nodes.

When possible, it can be beneficial to use the 24 bit I-RNTI due to the smaller size. Since the UE is configured with both the 24-bit and the 40-bit, the new NG-RAN node indicates over broadcast which of the two RRC messages the UE shall send. The network can then use the 24 bit I-RNTI when there are no conflicts with the 24-bit I-RNTI with its neighbors or the negative impact of a conflict is small.

### Specification Impact

In order for the NG-RAN nodes to understand which NG-RAN Address Indices are allocated to its neighbors new functionality in TS 38.423 (XnAP) is needed. In general, this information can be added to any interface over which the information needs to be exchanged between two nodes including signaling using the NG-interface and signal via the AMF or utilize operation and maintenance interfaces. The information which needs to be transferred from the node which makes a change to its neighbors/peers is:
Indicate NG-RAN Node Address Indices in use to peer(s)
Indicate removal of NG-RAN Node Address Index to peer(s).
Indicate addition of NG-RAN Node Address Index to peer(s).

Signalling for these embodiments of inventive concepts will support both full I-RNTI and short I-RNTI. Considering the current standard, both the 24-bit and the 40-bit I-RNTIs would need to be exchanged. Considering the existing messages suitable candidates would be the Xn Setup and Xn NG-RAN Node Configuration Update procedures. However, new messages can also be used. The new messages could be designed to include the complete list of I-RNTIs in use by the node.

However, an alternative is to also only send one NG-RAN Node Address Index value per message and let the receiver store the combined set of information. The information to send could be:
NG-RAN Node Address Index
Indication if the NG-RAN Node Address Index is added or removed
I-RNTI type i.e. 24 bits or 40 bits

Optionally a CRC check could be provided which is calculated over all values the receiver should have stored in memory. The purpose of the CRC check would be to ensure that the peers have the same information. An alternative to the CRC check is to acknowledge each received message (class 1 procedure according to 3GPP XnAP).

It is also possible to use separate messages for addition and removal.

It should be clarified that various embodiments of inventive concepts assumes that all nodes in the RAN are aware of the NG-RAN Node Address Index used by all other nodes. In one embodiment of this method the NG-RAN Node Address Index is of the same length for all nodes in the network.

In another embodiment of inventive concepts, the NG-RAN Node Address Index is of a given length for all RAN nodes in one specific group of RAN nodes, e.g. the group of RAN nodes supporting a given PLMN. In this embodiment, each RAN node would be configured with information regarding the length of the NG-RAN Node Address Index used by each group of RAN node.

In this embodiment, NG-RAN Node Address Index conflicts are resolved as described above. Namely, if a RAN node determines that its NG-RAN Node Address Index is in conflict with any neighbour's NG-RAN Node Address Index, that RAN node may trigger the process of deriving a new NG-RAN Node Address Index, making sure that such NG-RAN Node Address Index does not clash with any of the NG-RAN Node Address Index used by RAN nodes in the neighborhood, i.e. by RAN nodes that can be reached directly (e.g. via XnAP signaling) or indirectly (e.g. via NEAP signaling). Once such new NG-RAN Node Address Index is derived, the RAN node may signal to neighbor RAN nodes the new NG-RAN Node Address Index.

Similarly to described above, neighbours' NG-RAN Node Address Index may be signaled together with the NG-RAN Node Address Index of the node triggering the signaling.

### Example of Implementation where a NG RAN Node Uses One Local Node ID

An example of possible implementation for TS 38.423 (XnAP) is provided below, the parts underlined pertain to various embodiments inventive concepts described herein.
9.1.3.1 Xn Setup Request
This message is sent by a NG-RAN node to a neighbouring NG-RAN node to transfer application data for an Xn-C interface instance.
   Direction: NG-RAN Node₁→Ng-Ran Node₂.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| Global NG-RAN | M | | 9.2.2.3 | | YES | reject |
| Node ID | | | | | | |
| TAI Support List | M | | 9.2.3.20 | List of | YES | reject |
| | | | | supported | | |
| | | | | TAs and | | |
| | | | | associated | | |
| | | | | characteristics | | |
| AMF Region | M | | 9.2.3.83 | Contains a | YES | reject |
| Information | | | | list of all | | |
| | | | | the AMF | | |
| | | | | Regions to | | |
| | | | | which the | | |
| | | | | NG-RAN node | | |
| | | | | belongs. | | |
| List of Served | | 0 . . . | | Contains a | YES | reject |
| Cells NR | | <maxnoofCellsinNG- | | list of cells | | |
| | | RANnode> | | served by | | |
| | | | | the gNB. If | | |
| | | | | a partial list | | |
| | | | | of cells is | | |
| | | | | signalled, it | | |
| | | | | contains at | | |
| | | | | least one | | |
| | | | | cell per | | |
| | | | | carrier | | |
| | | | | configured | | |
| | | | | at the gNB | | |
| >Served Cell | M | | 9.2.2.11 | | — | |
| Information NR | | | | | | |
| >Neighbour | O | | 9.2.2.13 | | — | |
| Information NR | | | | | | |
| >Neighbour | O | | 9.2.2.14 | | | |
| Information E-UTRA | | | | | | |
| List of Served | | 0 . . . | | Contains a | YES | reject |
| Cells E-UTRA | | <maxnoofCellsinNG- | | list of cells | | |
| | | RANnode> | | served by | | |
| | | | | the ng- | | |
| | | | | eNB. If a | | |
| | | | | partial list | | |
| | | | | of cells is | | |
| | | | | signalled, it | | |
| | | | | contains at | | |
| | | | | least one | | |
| | | | | cell per | | |
| | | | | carrier | | |
| | | | | configured | | |
| | | | | at the ng-eNB | | |
| >Served Cell | M | | 9.2.2.12 | | — | |
| Information E- | | | | | | |
| UTRA | | | | | | |
| >Neighbour | 0 | | 9.2.2.13 | | — | |
| Information NR | | | | | | |
| >Neighbour | 0 | | 9.2.2.14 | | — | |
| Information E- | | | | | | |
| UTRA | | | | | | |
| Interface Instance | O | | 9.2.2.39 | | YES | reject |
| Indication | | | | | | |
| TNL | O | | 9.2.3.96 | | YES | ignore |
| Configuration Info | | | | | | |
| Partial List | O | | Partial List | Value | YES | ignore |
| Indicator NR | | | Indicator | “partial” | | |
| | | | 9.2.2.46 | indicates | | |
| | | | | that a | | |
| | | | | partial list | | |
| | | | | of cells is | | |
| | | | | included in | | |
| | | | | the List of | | |
| | | | | Served | | |
| | | | | Cells NR | | |
| | | | | IE. | | |
| Cell and Capacity | 0 | | 9.2.2.41 | Contains | YES | ignore |
| Assistance | | | | NR cell | | |
| Information NR | | | | related | | |
| | | | | assistance | | |
| Partial List | 0 | | Partial List | information | YES | ignore |
| | | | Indicator | | | |
| Indicator E-UTRA | | | 9.2.2.46 | Value | | |
| | | | | “partial” | | |
| | | | | indicates | | |
| | | | | that a | | |
| | | | | partial list | | |
| | | | | of cells is | | |
| | | | | included in | | |
| | | | | the List of | | |
| | | | | Served | | |
| | | | | Cells E- | | |
| | | | | UTRA. | | |
| Cell and Capacity | 0 | | 9.2.2.42 | Contains E- | YES | Ignore |
| Assistance | | | | UTRA cell | | |
| Information E- | | | | related | | |
| UTRA | | | | assistance | | |
| | | | | information | | |
| Local NG-RAN | O | | 9.2.2.x | | YES | Ignore |
| Node Identifier | | | | | | |
| Neighbouring | | 0 . . . | | | YES | Ignore |
| NG-RAN Node | | <maxnoofNeighbouringNG- | | | | |
| Identifier List | | RANnode> | | | | |
| > Global NG- | M | | 9.2.2.3 | | — | — |
| RAN Node ID | | | | | | |
| > Neighbour | M | | 9.2.2.x | | — | — |
| NG-RAN Node | | | | | | |
| Identifier | | | | | | |

| Range bound | Explanation |
|---|---|
| maxnoofCellsinNG-RAN | Maximum no. cells that can be served by a |
| node | NG-RAN node. Value is 16384. |
| maxnoofNeighbouringNG- | Maximum no. neighbouring NG-RAN |
| RAN node | nodes. Value is 1024. |

### 9.1.3.2 XN Setup Response

This message is sent by a NG-RAN node to a neighbouring NG-RAN node to transfer application data for an Xn-C interface instance.

Direction: NG-RAN Node₂→NG-RAN Node₁.

| IE/Group | | | IE type and | Semantics | | Assigned |
|---|---|---|---|---|---|---|
| Name | Presence | Range | reference | description | Criticality | Criticality |
| Message Type | M | | 9.2.3.1 | | YES | reject |
| Global NG- | M | | 9.2.2.3 | | YES | reject |
| RAN Node ID | | | | | | |
| TAI Support | M | | 9.2.3.20 | List of | YES | reject |
| List | | | | supported | | |
| | | | | TAs and | | |
| | | | | associated | | |
| | | | | characteristics. | | |
| List of Served | | 0 . . . | | Contains a | YES | reject |
| Cells NR | | <maxnoofCellsinNG- | | list of cells | | |
| | | RANnode> | | served by | | |
| | | | | the gNB. If | | |
| | | | | a partial list | | |
| | | | | of cells is | | |
| | | | | signalled, it | | |
| | | | | contains at | | |
| | | | | least one | | |
| | | | | cell per | | |
| | | | | carrier | | |
| | | | | configured | | |
| | | | | at the gNB | | |
| >Served Cell | M | | 9.2.2.11 | | | |
| Information NR | | | | | | |
| >Neighbour | O | | 9.2.2.13 | | — | |
| Information NR | | | | | | |
| >Neighbour | O | | 9.2.2.14 | | — | |
| Information E- | | | | | | |
| UTRA | | | | | | |
| List of Served | | 0 . . . | | Contains a | YES | reject |
| Cells E-UTRA | | <maxnoofCellsinNG- | | list of cells | | |
| | | RANnode> | | served by | | |
| | | | | the ng- | | |
| | | | | eNB. If a | | |
| | | | | partial list | | |
| | | | | of cells is | | |
| | | | | signalled, it | | |
| | | | | contains at | | |
| | | | | least one | | |
| | | | | cell per | | |
| | | | | carrier | | |
| | | | | configured | | |
| | | | | at the gNB | | |
| >Served Cell | M | | 9.2.2.12 | | — | |
| Information E- | | | | | | |
| UTRA | | | | | | |
| >Neighbour | O | | 9.2.2.13 | | — | |
| Information | | | | | | |
| NR | | | | | | |
| >Neighbour | O | | 9.2.2.14 | | — | |
| Information E- | | | | | | |
| UTRA | | | | | | |
| Criticality | O | | 9.2.3.3 | | YES | ignore |
| Diagnostics | | | | | | |
| AMF Region | O | | 9.2.3.83 | Contains a | YES | reject |
| Information | | | | list of all | | |
| | | | | the AMF | | |
| | | | | Regions to | | |
| | | | | which the | | |
| | | | | NG-RAN node | | |
| | | | | belongs. | | |
| Interface | O | | 9.2.2.39 | | YES | reject |
| Instance | | | | | | |
| Indication | | | | | | |
| TNL | O | | 9.2.3.96 | | YES | ignore |
| Configuration | | | | | | |
| Info | | | | | | |
| Partial List | O | | Partial | Value | YES | ignore |
| Indicator NR | | | List | “partial” | | |
| | | | Indicator | indicates | | |
| | | | 9.2.2.46 | that a | | |
| | | | | partial list | | |
| | | | | of cells is | | |
| | | | | included in | | |
| | | | | the List of | | |
| | | | | Served Cells | | |
| | | | | NR IE. | | |
| Cell and | O | | 9.2.2.41 | Contains NR | YES | ignore |
| Capacity | | | | cell related | | |
| Assistance | | | | assistance | | |
| Information NR | | | | information | | |
| Partial List | O | | Partial | Value | YES | ignore |
| Indicator E- | | | List | “partial” | | |
| UTRA | | | Indicator | indicates | | |
| | | | 9.2.2.46 | that a | | |
| | | | | partial list | | |
| | | | | of cells is | | |
| | | | | included in | | |
| | | | | the List of | | |
| | | | | Served | | |
| | | | | Cells E-UTRA. | | |
| Cell and | O | | 9.2.2.42 | Contains E- | YES | Ignore |
| Capacity | | | | UTRA cell | | |
| Assistance | | | | related | | |
| Information E- | | | | assistance | | |
| UTRA | | | | information | | |
| Local NG-RAN | O | | 9.2.2.x | | YES | Ignore |
| Node Identifier | | | | | | |
| Neighbouring | | 0 . . . | | | YES | Ignore |
| NG-RAN Node | | <maxnoofNeighbouringNG- | | | | |
| Identifier List | | RANnode> | | | | |
| > Global NG- | M | | 9.2.2.3 | | — | — |
| RAN Node ID | | | | | | |
| > Neighbour | M | | 9.2.2.x | | — | — |
| NG-RAN Node | | | | | | |
| Identifier | | | | | | |

| Range bound | Explanation |
|---|---|
| maxnoofCellsinNG-RAN | Maximum no. cells that can be served by a |
| node | NG-RAN node. Value is 16384. |
| maxnoofNeighbouringNG- | Maximum no. neighbouring NG-RAN |
| RAN node | nodes. Value is 1024. |

### 9.1.3.4 NG-RAN Node Configuration Update

This message is sent by a NG-RAN node to a neighbouring NG-RAN node to transfer updated information for an Xn-C interface instance.

Direction: NG-RAN Node₁→NG-RAN Node₂.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| TAI Support List | O | | 9.2.3.20 | List of | GLOBAL | reject |
| | | | | supported TAs | | |
| | | | | and associated | | |
| | | | | characteristics. | | |
| CHOICE | M | | | | YES | ignore |
| Initiating | | | | | | |
| Node Type | | | | | | |
| >gNB | | | | | | |
| >>Served Cells | O | | 9.2.2.15 | | YES | ignore |
| To Update NR | | | | | | |
| >>Cell | O | | 9.2.2.17 | | YES | ignore |
| Assistance | | | | | | |
| Information NR | | | | | | |
| >>Cell | O | | 9.2.2.43 | | YES | ignore |
| Assistance | | | | | | |
| Information E-UTRA | | | | | | |
| >ng-eNB | | | | | | |
| >>Served Cells | O | | 9.2.2.16 | | YES | ignore |
| to Update E-UTRA | | | | | | |
| >>Cell | O | | 9.2.2.17 | | YES | ignore |
| Assistance | | | | | | |
| Information NR | | | | | | |
| >>Cell | O | | 9.2.2.43 | | YES | ignore |
| Assistance | | | | | | |
| Information E-UTRA | | | | | | |
| TNLA To Add List | | 0 . . . 1 | | | YES | ignore |
| >TNLA To | | 1 . . . | | | | |
| Add Item | | <maxnoofTNLASsociations> | | | | |
| >>TNLA | M | | CP | CP | | |
| Transport | | | Transport | Transport | | |
| Layer | | | Layer | Layer | | |
| Information | | | Information | Information | | |
| | | | 9.2.3.31 | of NG-RAN node₁ | | |
| >> TNL Association | M | | 9.2.3.84 | | — | |
| Usage | | | | | | |
| TNLA To | | 0 . . . 1 | | | YES | ignore |
| Update List | | | | | | |
| >TNLA To | | 1 . . . | | | — | |
| Update Item | | <maxnoofTNLASsociations> | | | | |
| >>TNLA | M | | CP | CP | | |
| Transport | | | Transport | Transport | | |
| Layer | | | Layer | Layer | | |
| Information | | | Information | Information | | |
| | | | 9.2.3.31 | of NG-RAN node₁ | | |
| >> TNL | O | | 9.2.3.84 | | — | |
| Association | | | | | | |
| Usage | | | | | | |
| TNLA To | | 0 . . . 1 | | | YES | ignore |
| Remove List | | | | | | |
| >TNLA To | | 1 . . . | | | — | |
| Remove Item | | <maxnoofTNLASsociations> | | | | |
| >>TNLA Transport | M | | CP | CP | | |
| Layer Information | | | Transport | Transport | | |
| | | | Layer | Layer | | |
| | | | Information | Information | | |
| | | | 9.2.3.31 | of NG-RAN node₁ | | |
| Global NG-RAN | O | | 9.2.2.3 | | YES | reject |
| Node ID | | | | | | |
| AMF Region | O | | AMF | List of all | YES | reject |
| Information To | | | Region | added AMF | | |
| Add | | | Information | Regions | | |
| | | | 9.2.3.83 | to which | | |
| | | | | the NG-RAN node | | |
| | | | | belongs. | | |
| AMF Region | O | | AMF | List of all | YES | reject |
| Information To | | | Region | deleted | | |
| Delete | | | Informatio | AMF Regions | | |
| | | | n 9.2.3.83 | to which | | |
| | | | | the NG-RAN node | | |
| | | | | belongs. | | |
| Interface Instance | O | | 9.2.2.39 | | YES | reject |
| Indication | | | | | | |
| TNL Configuration | O | | 9.2.3.96 | | YES | Ignore |
| Info | | | | | | |
| Local NG-RAN | O | | 9.2.2.x | | YES | Ignore |
| Node Identifier | | | | | | |
| Neighbouring | | 0 . . . | | | YES | Ignore |
| NG-RAN Node | | <maxnoofNeighbouringNG- | | | | |
| Identifier List | | RANnode> | | | | |
| > Global NG- | M | | 9.2.2.3 | | — | — |
| RAN Node ID | | | | | | |
| > Neighbour | M | | 9.2.2.x | | — | — |
| NG-RAN Node | | | | | | |
| Identifier | | | | | | |

| Range bound | Explanation |
|---|---|
| maxnoofTNLAssociations | Maximum numbers of TNL Associations |
| | between the NG RAN nodes. Value is 32. |
| maxnoofNeighbouringNG- | Maximum no. neighbouring NG-RAN |
| RAN node | nodes. Value is 1024. |

### 9.1.3.5 NG-RAN Node Configuration Update Acknowledge

This message is sent by a neighbouring NG-RAN node to a peer node to acknowledge update of information for a TNL association.

Direction: NG-RAN node₁→NG-RAN node₁.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| CHOICE | M | | | | YES | ignore |
| Responding | | | | | | |
| NodeType | | | | | | |
| >ng-eNB | | | | | | |
| >gNB | | | | | | |
| >>Served E- | | 0 . . . | | Complete | YES | ignore |
| UTRA Cells | | <maxnoofCellsinNG- | | or limited | | |
| | | RANnode> | | list of cells | | |
| | | | | served by | | |
| | | | | an ng-eNB, | | |
| | | | | if requested | | |
| | | | | by NG-RAN node₁. | | |
| >>>Served | M | | 9.2.2.12 | | — | |
| Cell | | | | | | |
| Information E-UTRA | | | | | | |
| >>>Neighbour | O | | 9.2.2.13 | NR | — | |
| Information NR | | | | neighbours. | | |
| >>>Neighbour | O | | 9.2.2.14 | E-UTRA | | |
| Information E-UTRA | | | | neighbours | | |
| >>Partial List | O | | Partial | Value | YES | ignore |
| Indicator E-UTRA | | | List | “partial” | | |
| | | | Indicator | indicates | | |
| | | | 9.2.2.46 | that a | | |
| | | | | partial list | | |
| | | | | of cells is | | |
| | | | | included | | |
| | | | | in the | | |
| | | | | Served E-UTRA | | |
| | | | | Cells IE | | |
| >>Cell and | O | | 9.2.2.42 | Contains | YES | ignore |
| Capacity | | | | E-UTRA cell | | |
| Assistance | | | | related | | |
| Information E-UTRA | | | | assistance | | |
| | | | | information. | | |
| >>Served NR | | 0 . . . | | Complete | | |
| Cells | | <maxnoofCellsinNG- | | or limited | | |
| | | RANnode> | | list of cells | | |
| | | | | served by | | |
| | | | | a gNB, if | | |
| | | | | requested by | | |
| | | | | NG-RAN node₁. | | |
| >>>Served | M | | 9.2.2.11 | | — | |
| Cell | | | | | | |
| Information NR | | | | | | |
| >>>Neighbour | O | | 9.2.2.13 | NR | — | |
| Information NR | | | | neighbours. | | |
| >>>Neighbour | O | | 9.2.2.14 | E-UTRA | — | |
| Information E-UTRA | | | | neighbours | | |
| >>Partial List | O | | Partial | Value | YES | ignore |
| Indicator NR | | | List | “partial” | | |
| | | | Indicator | indicates | | |
| | | | 9.2.2.46 | that a | | |
| | | | | partial list | | |
| | | | | of cells is | | |
| | | | | included in | | |
| | | | | the Served | | |
| | | | | NR Cells IE | | |
| >>Cell and | O | | 9.2.2.41 | Contains | YES | ignore |
| Capacity | | | | NR cell | | |
| Assistance | | | | related | | |
| Information NR | | | | assistance | | |
| | | | | information. | | |
| TNLA Setup List | | 0 . . . 1 | | | YES | ignore |
| >TNLA Setup | | 1 . . . | | | - | |
| Item | | <maxnoofTNLAssociations> | | | | |
| >>TNLA | M | | CP | CP | | |
| Transport Layer | | | Transport | Transport | | |
| Address | | | Layer | Layer | | |
| | | | Information | Information | | |
| | | | 9.2.3.31 | as received | | |
| | | | | from NG-RAN node₁ | | |
| TNLA Failed to | | 0 . . . 1 | | | YES | ignore |
| Setup Lis | | | | | | |
| >TNLA Failed | | 1 . . . | | | — | |
| To Setup Item | | <maxnoofTNLAssociations> | | | | |
| >>TNLA | M | | CP | CP | — | |
| Transport Layer | | | Transport | Transport | | |
| Address | | | Layer | Layer | | |
| | | | Information | Information | | |
| | | | 9.2.3.31 | as received | | |
| | | | | from NG-RAN | | |
| | | | | node₁ | | |
| >>Cause | M | | 9.2.3.2 | | — | |
| Criticality | O | | 9.2.3.3 | | YES | ignore |
| Diagnostics | | | | | | |
| Interface Instance | O | | 9.2.2.39 | | YES | reject |
| Indication | | | | | | |
| TNL | O | | 9.2.3.96 | | YES | Ignore |
| Configuration Info | | | | | | |
| Local NG-RAN | O | | 9.2.2.x | | YES | Ignore |
| Node Identifier | | | | | | |
| Neighbouring | | 0 . . . | | | YES | Ignore |
| NG-RAN Node | | <maxnoofNeighbouringNG- | | | | |
| Identifier List | | RANnode> | | | | |
| > Global NG- | M | | 9.2.2.3 | | — | — |
| RAN Node ID | | | | | | |
| > Neighbour | M | | 9.2.2.x | | — | — |
| NG-RAN Node | | | | | | |
| Identifier | | | | | | |

| Range bound | Explanation |
|---|---|
| maxnoofCellsinNGRANnode | Maximum no. cells that can be served by |
| | an NG-RAN node. |
| | Value is 16384. |
| maxnoofTNLAssociations | Maximum numbers of TNL Associations |
| | between NG-RAN nodes. Value is 32. |
| maxnoofNeighbouringNG- | Maximum no. neighbouring NG-RAN |
| RAN node | nodes. Value is 1024. |

### 9.2.2.x Local NG-RAN Node Identifier

This IE is used to identify an NG-RAN node within a set of NG-RAN nodes that can interoperate over the Xn-C interface.

| | | | | |
|---|---|---|---|---|
| | | | IE type and | Semantics |
| IE/Group Name | Presence | Range | reference | description |

| | | |
|---|---|---|
| CHOICE Full I-RNTI | M | |
| > CHOICE I-RNTI profile | | |
| >> I-RNTI profile 0 | | |
| >>> Local Node Identifier I- | | BIT STRING |
| RNTI profile 0 | | (SIZE(22)) |
| >> I-RNTI profile 1 | | |
| >>> Local Node Identifier I- | | BIT STRING |
| RNTI profile 1 | | (SIZE(18)) |
| >> I-RNTI profile 2 | | |
| >>> Local Node Identifier I- | | BIT STRING |
| RNTI profile 2 | | (SIZE(15)) |
| >> I-RNTI profile 3 | | |
| >>> Local Node Identifier I- | | BIT STRING |
| RNTI profile 3 | | (SIZE(12)) |
| CHOICE Short I-RNTI | M | |
| > CHOICE I-RNTI profile | | |
| >> I-RNTI profile 0 | | |
| >>> Local Node Identifier I- | | BIT STRING |
| RNTI profile 0 | | (SIZE(8)) |
| >> I-RNTI profile 1 | | |
| >>> Local Node Identifier I- | | BIT STRING |
| RNTI profile 1 | | (SIZE(6)) |

### Example of Implementation where a NG RAN Node Uses More than One Local Node ID

An example of possible implementation for TS 38.423 (XnAP) is provided below, the parts underlined pertain to various embodiments inventive concepts described herein.

### 9.1.3.1 XN Setup Request

This message is sent by a NG-RAN node to a neighbouring NG-RAN node to transfer application data for an Xn-C interface instance.

Direction: NG-RAN Node₁→NG-RAN Node₂.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| Global NG-RAN Node ID | M | | 9.2.2.3 | | YES | reject |
| TAI Support List | M | | 9.2.3.20 | List of | YES | reject |
| | | | | supported | | |
| | | | | TAs and | | |
| | | | | associated | | |
| | | | | characteristics. | | |
| AMF Region Information | M | | 9.2.3.83 | Contains a | YES | reject |
| | | | | list of all the | | |
| | | | | AMF Regions | | |
| | | | | to which the | | |
| | | | | NG-RAN node | | |
| | | | | belongs. | | |
| List of Served Cells NR | | 0 . . . | | Contains a | YES | reject |
| | | <maxnoofCellsinNG- | | list of cells | | |
| | | RANnode> | | served by | | |
| | | | | the gNB. | | |
| | | | | If a partial | | |
| | | | | list of | | |
| | | | | cells is | | |
| | | | | signalled, | | |
| | | | | it contains | | |
| | | | | at least | | |
| | | | | one cell | | |
| | | | | per carrier | | |
| | | | | configured | | |
| | | | | at the gNB | | |
| >Served Cell | M | | 9.2.2.11 | | — | |
| Information NR | | | | | | |
| >Neighbour | O | | 9.2.2.13 | | — | |
| Information NR | | | | | | |
| >Neighbour | O | | 9.2.2.14 | | — | |
| Information E-UTRA | | | | | | |
| List of Served Cells | | 0 . . . | | Contains a | YES | reject |
| E-UTRA | | <maxnoofCellsinNG- | | list of cells | | |
| | | RANnode> | | served by | | |
| | | | | the ng-eNB | | |
| | | | | If a partial | | |
| | | | | list of cells | | |
| | | | | is signalled, | | |
| | | | | it contains | | |
| | | | | at least | | |
| | | | | one cell | | |
| | | | | per carrier | | |
| | | | | configured | | |
| | | | | at the ng-eNB | | |
| >Served Cell | M | | 9.2.2.12 | | - | |
| Information E-UTRA | | | | | | |
| >Neighbour | O | | 9.2.2.13 | | - | |
| Information NR | | | | | | |
| >Neighbour | O | | 9.2.2.14 | | - | |
| Information E-UTRA | | | | | | |
| Interface Instance | O | | 9.2.2.39 | | YES | reject |
| Indication | | | | | | |
| TNL Configuration Info | O | | 9.2.3.96 | | YES | ignore |
| Partial List Indicator | O | | Partial List | Value | YES | ignore |
| NR | | | Indicator | “partial” | | |
| | | | 9.2.2.46 | indicates | | |
| | | | | that a | | |
| | | | | partial list | | |
| | | | | of cells is | | |
| | | | | included | | |
| | | | | in the List | | |
| | | | | of Served | | |
| | | | | Cells NR IE. | | |
| Cell and Capacity | O | | 9.2.2.41 | Contains | YES | ignore |
| Assistance Information | | | | NR cell | | |
| NR | | | | related | | |
| | | | | assistance | | |
| | | | | information. | | |
| Partial List Indicator | O | | Partial List | Value | YES | ignore |
| E-UTRA | | | Indicator | “partial” | | |
| | | | 9.2.2.46 | indicates | | |
| | | | | that a | | |
| | | | | partial list | | |
| | | | | of cells is | | |
| | | | | included | | |
| | | | | in the List | | |
| | | | | of Served | | |
| | | | | Cells E-UTRA. | | |
| Cell and Capacity | O | | 9.2.2.42 | Contains | YES | Ignore |
| Assistance Information | | | | E-UTRA cell | | |
| E-UTRA | | | | related | | |
| | | | | assistance | | |
| | | | | information. | | |
| Local NG-RAN Node | | 0 . . . | | | YES | Ignore |
| Identifier List | | <maxnoofLocalNG- | | | | |
| | | RANnodeID> | | | | |
| >Local NG-RAN | O | | BITSTRING | Depending | YES | Ignore |
| Node Identifier | | | (40) | on node | | |
| | | | | configuration, | | |
| | | | | the n most | | |
| | | | | significant | | |
| | | | | bits | | |
| | | | | represent | | |
| | | | | the Local | | |
| | | | | Node ID of | | |
| | | | | the RAN | | |
| | | | | node. For | | |
| | | | | example, if | | |
| | | | | the Local | | |
| | | | | Node ID is | | |
| | | | | configured | | |
| | | | | to be of | | |
| | | | | 30 bits, | | |
| | | | | n == 30 | | |
| Neighbouring NG-RAN | | 0 . . . | | | YES | Ignore |
| Node Identifier List | | <maxnoofNeighbouringNG- | | | | |
| | | RANnode> | | | | |
| > Global NG-RAN | M | | 9.2.2.3 | | — | — |
| Node ID | | | | | | |
| > Neighbour NG-RAN | M | | 9.2.2.x | | — | — |
| Node Identifier | | | | | | |

| Range bound | Explanation |
|---|---|
| maxnoofCellsinNG- | Maximum no. cells that can be served by a |
| RAN node | NG-RAN node. Value is 16384. |
| maxnoofLocalNG- | Maximum no. Local NG-RAN node IDs per |
| RAN nodeID | RAN node. Value is 1024. |

### 9.1.3.2 XN Setup Response

This message is sent by a NG-RAN node to a neighbouring NG-RAN node to transfer application data for an Xn-C interface instance.

Direction: NG-RAN Node₁→NG-RAN Node₁.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| Global NG-RAN | M | | 9.2.2.3 | | YES | reject |
| Node ID | | | | | | |
| TAI Support List | M | | 9.2.3.20 | List of | YES | reject |
| | | | | supported | | |
| | | | | TAs and | | |
| | | | | associated | | |
| | | | | characteristics. | | |
| List of Served | | 0 . . . | | Contains a | YES | reject |
| Cells NR | | <maxnoofCellsinNG- | | list of cells | | |
| | | RANnode> | | served by | | |
| | | | | the gNB. If | | |
| | | | | a partial list | | |
| | | | | of cells is | | |
| | | | | signalled, it | | |
| | | | | contains at | | |
| | | | | least one | | |
| | | | | cell per | | |
| | | | | carrier | | |
| | | | | configured | | |
| | | | | at the gNB | | |
| >Served Cell | M | | 9.2.2.11 | | — | |
| Information NR | | | | | | |
| >Neighbour | 0 | | 9.2.2.13 | | — | |
| Information NR | | | | | | |
| >Neighbour | 0 | | 9.2.2.14 | | — | |
| Information E- | | | | | | |
| UTRA | | | | | | |
| List of Served | | 0 . . . | | Contains a | YES | reject |
| Cells E-UTRA | | <maxnoofCellsinNG- | | list of cells | | |
| | | RANnode> | | served by | | |
| | | | | the ng-eNB. | | |
| | | | | If a partial | | |
| | | | | list of cells | | |
| | | | | is signalled, | | |
| | | | | it contains at | | |
| | | | | least one | | |
| | | | | cell per | | |
| | | | | carrier | | |
| | | | | configured | | |
| | | | | at the gNB | | |
| >Served Cell | M | | 9.2.2.12 | | — | |
| Information E-UTRA | | | | | | |
| >Neighbour | O | | 9.2.2.13 | | — | |
| Information NR | | | | | | |
| >Neighbour | O | | 9.2.2.14 | | — | |
| Information E-UTRA | | | | | | |
| Criticality | O | | 9.2.3.3 | | YES | ignore |
| Diagnostics | | | | | | |
| AMF Region | O | | 9.2.3.83 | Contains a | YES | reject |
| Information | | | | list of all the | | |
| | | | | AMF Regions to | | |
| | | | | which the | | |
| | | | | NG-RAN node | | |
| | | | | belongs. | | |
| Interface Instance | O | | 9.2.2.39 | | YES | reject |
| Indication | | | | | | |
| TNL Configuration | O | | 9.2.3.96 | | YES | ignore |
| Info | | | | | | |
| Partial List | O | | Partial | Value | YES | ignore |
| Indicator NR | | | List | “partial” | | |
| | | | Indicator | indicates | | |
| | | | 9.2.2.46 | that a partial | | |
| | | | | list of cells | | |
| | | | | is included | | |
| | | | | in the List of | | |
| | | | | Served Cells | | |
| | | | | NR IE. | | |
| Cell and Capacity | O | | 9.2.2.41 | Contains NR | YES | ignore |
| Assistance | | | | cell related | | |
| Information NR | | | | assistance | | |
| | | | | information. | | |
| Partial List | O | | Partial | Value | YES | ignore |
| Indicator E-UTRA | | | List | “partial” | | |
| | | | Indicator | indicates | | |
| | | | 9.2.2.46 | that a partial | | |
| | | | | list of cells | | |
| | | | | is included | | |
| | | | | in the List of | | |
| | | | | Served Cells | | |
| | | | | E-UTRA. | | |
| Cell and Capacity | O | | 9.2.2.42 | Contains E- | YES | Ignore |
| Assistance | | | | UTRA cell | | |
| Information E- | | | | related | | |
| UTRA | | | | assistance | | |
| | | | | information. | | |
| Local NG-RAN | | 0 . . . | | | YES | Ignore |
| Node Identifier List | | <maxnoofLocalNG- | | | | |
| | | RANnodeID> | | | | |
| >Local NG-RAN | O | | BITSTRING | Depending | YES | Ignore |
| Node Identifier | | | (40) | on node | | |
| | | | | configuration, | | |
| | | | | the n most | | |
| | | | | significant | | |
| | | | | bits | | |
| | | | | represent the | | |
| | | | | Local Node | | |
| | | | | ID of the | | |
| | | | | RAN node. | | |
| | | | | For example, | | |
| | | | | if the Local | | |
| | | | | Node ID is | | |
| | | | | configured | | |
| | | | | to be of 30 | | |
| | | | | bits, n == 30 | | |
| Neighbouring NG- | | 0 . . . | | | YES | Ignore |
| RAN Node | | <maxnoofNeighbouringNG- | | | | |
| Identifier List | | RANnode> | | | | |
| > Global NG- | M | | 9.2.2.3 | | — | — |
| RAN Node ID | | | | | | |
| > Neighbour NG- | M | | 9.2.2.x | | — | — |
| RAN Node | | | | | | |
| Identifier | | | | | | |

| Range bound | Explanation |
|---|---|
| maxnoofCellsinNG- | Maximum no. cells that can be served by a |
| RAN node | NG-RAN node. Value is 16384. |
| maxnoofLocalNG- | Maximum no. Local NG-RAN node IDs per |
| RAN nodeID | RAN node. Value is 1024. |

### 9.1.3.4 NG-RAN Node Configuration Update

This message is sent by a NG-RAN node to a neighbouring NG-RAN node to transfer updated information for an Xn-C interface instance.

Direction: NG-RAN noder→NG-RAN node₂.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| TAI Support List | O | | 9.2.3.20 | List of | GLOBAL | reject |
| | | | | supported TAs | | |
| | | | | and associated | | |
| | | | | characteristics. | | |
| CHOICE Initiating | M | | | | YES | ignore |
| Node Type | | | | | | |
| >gNB | | | | | | |
| >>Served Cells To | O | | 9.2.2.15 | | YES | ignore |
| Update NR | | | | | | |
| >>Cell Assistance | O | | 9.2.2.17 | | YES | ignore |
| Information NR | | | | | | |
| >>Cell Assistance | O | | 9.2.2.43 | | YES | ignore |
| Information E- | | | | | | |
| UTRA | | | | | | |
| >ng-eNB | | | | | | |
| >>Served Cells to | O | | 9.2.2.16 | | YES | ignore |
| Update E-UTRA | | | | | | |
| >>Cell Assistance | O | | 9.2.2.17 | | YES | ignore |
| Information NR | | | | | | |
| >>Cell Assistance | O | | 9.2.2.43 | | YES | ignore |
| Information E- | | | | | | |
| UTRA | | | | | | |
| TNLA To Add List | | 0 . . . 1 | | | YES | ignore |
| >TNLA To Add | | 1 . . . | | | — | |
| Item | | <maxnoofTNLAssociations> | | | | |
| >>TNLA | M | | CP Transport | CP Transport | — | |
| Transport Layer | | | Layer | Layer | | |
| Information | | | Information | Information | | |
| | | | 9.2.3.31 | of NG-RAN node₁ | | |
| >> TNL | M | | 9.2.3.84 | | — | |
| Association Usage | | | | | | |
| TNLA To Update | | 0 . . . 1 | | | YES | ignore |
| List | | | | | | |
| >TNLA To Update | | 1 . . . | | | — | |
| Item | | <maxnoofTNLAssociations> | | | | |
| >>TNLA | M | | CP Transport | CP Transport | | |
| Transport Layer | | | Layer | Layer | | |
| Information | | | Information | Information | | |
| | | | 9.2.3.31 | of NG-RAN node₁ | | |
| >> TNL | O | | 9.2.3.84 | | — | |
| Association Usage | | | | | | |
| TNLA To Remove | | 0 . . . 1 | | | YES | ignore |
| List | | | | | | |
| >TNLA To | | 1 . . . | | | — | |
| Remove Item | | <maxnoofTNLAssociations> | | | | |
| >>TNLA | M | | CP Transport | CP Transport | — | |
| Transport Layer | | | Layer | Layer | | |
| Information | | | Information | Information | | |
| | | | 9.2.3.31 | of NG-RAN node₁ | | |
| Global NG-RAN | O | | 9.2.2.3 | | YES | reject |
| Node ID | | | | | | |
| AMF Region | O | | AMF Region | List of all | YES | reject |
| Information To Add | | | Information | added AMF | | |
| | | | 9.2.3.83 | Regions to | | |
| | | | | which the | | |
| | | | | NG-RAN node | | |
| | | | | belongs. | | |
| AMF Region | O | | AMF Region | List of all | YES | reject |
| Information To | | | Information | deleted | | |
| Delete | | | 9.2.3.83 | AMF Regions to | | |
| | | | | which the NG- | | |
| | | | | RAN node | | |
| | | | | belongs. | | |
| Interface Instance | O | | 9.2.2.39 | | YES | reject |
| Indication | | | | | | |
| TNL Configuration | O | | 9.2.3.96 | | YES | Ignore |
| Info | | | | | | |
| Local NG-RAN | | 0 . . . | | | YES | Ignore |
| Node Identifier List | | <maxnoofLocalNG- | | | | |
| | | RANnodeID> | | | | |
| >Local NG-RAN | O | | BITSTRING | Depending | YES | Ignore |
| Node Identifier | | | (40) | on node | | |
| | | | | configuration, | | |
| | | | | the n most | | |
| | | | | significant | | |
| | | | | bits represent | | |
| | | | | the Local | | |
| | | | | Node ID | | |
| | | | | of the RAN | | |
| | | | | node. For | | |
| | | | | example, if | | |
| | | | | the Local | | |
| | | | | Node ID | | |
| | | | | is configured | | |
| | | | | to be of 30 | | |
| | | | | bits, n == 30 | | |
| Neighbouring NG- | | 0 . . . | | | YES | Ignore |
| RAN Node Identifier | | <maxnoofNeighbouringNG- | | | | |
| List | | RANnode> | | | | |
| > Global NG-RAN | M | | 9.2.2.3 | | — | — |
| Node ID | | | | | | |
| > Neighbour NG-RAN | M | | 9.2.2.x | | — | — |
| Node Identifier | | | | | | |

| Range bound | Explanation |
|---|---|
| maxnoofTNLAssociations | Maximum numbers of TNL Associations |
| | between the NG RAN nodes. Value is 32. |
| maxnoofLocalNG- | Maximum no. Local NG-RAN node IDs |
| RAN nodeID | per RAN node. Value is 1024. |

### 9.1.3.5 NG-RAN Node Configuration Update Acknowledge

This message is sent by a neighbouring NG-RAN node to a peer node to acknowledge update of information for a TNL association.

Direction: NG-RAN Node₁→NG-RAN Node₂

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| CHOICE | M | | | | YES | ignore |
| Responding | | | | | | |
| NodeType | | | | | | |
| >ng-eNB | | | | | | |
| >gNB | | | | | | |
| >>Served E-UTRA | | 0 . . . | | Complete | YES | ignore |
| Cells | | <maxnoofCellsinNG- | | or limited | | |
| | | RANnode> | | list of cells | | |
| | | | | served by an | | |
| | | | | ng-eNB, if | | |
| | | | | requested | | |
| | | | | by NG- | | |
| | | | | RAN node₁. | | |
| >>>Served Cell | M | | 9.2.2.12 | | | |
| Information E-UTRA | | | | | | |
| >>>Neighbour | O | | 9.2.2.13 | NR neighbours. | — | |
| Information NR | | | | | | |
| >>>Neighbour | O | | 9.2.2.14 | E-UTRA | | |
| Information E-UTRA | | | | neighbours | | |
| >>Partial List | O | | Partial | Value “partial” | YES | ignore |
| Indicator E-UTRA | | | List | indicates that | | |
| | | | Indicator | a partial list | | |
| | | | 9.2.2.46 | of cells is | | |
| | | | | included in the | | |
| | | | | Served E-UTRA | | |
| | | | | Cells IE | | |
| >>Cell and | O | | 9.2.2.42 | Contains | YES | ignore |
| Capacity | | | | E-UTRA | | |
| Assistance | | | | cell related | | |
| Information E-UTRA | | | | assistance | | |
| | | | | information. | | |
| >>Served NR | | 0 . . . | | Complete or | | |
| Cells | | <maxnoofCellsinNG- | | limited list | | |
| | | RANnode> | | of cells | | |
| | | | | served by | | |
| | | | | a gNB, if | | |
| | | | | requested | | |
| | | | | by NG- | | |
| | | | | RAN node₁. | | |
| >>>Served Cell | M | | 9.2.2.11 | | - | |
| Information NR | | | | | | |
| >>>Neighbour | O | | 9.2.2.13 | NR | - | |
| Information NR | | | | neighbours. | | |
| >>>Neighbour | O | | 9.2.2.14 | E-UTRA | | |
| Information E-UTRA | | | | neighbours | | |
| >>Partial List | O | | Partial | Value “partial” | YES | ignore |
| Indicator NR | | | List | indicates that | | |
| | | | Indicator | a partial list | | |
| | | | 9.2.2.46 | of cells is | | |
| | | | | included in the | | |
| | | | | Served NR | | |
| | | | | Cells IE | | |
| >>Cell and | O | | 9.2.2.41 | Contains NR | YES | ignore |
| Capacity | | | | cell related | | |
| Assistance | | | | assistance | | |
| Information NR | | | | information. | | |
| TNLA Setup List | | 0 . . . 1 | | | YES | ignore |
| >TNLA Setup | | 1 . . . | | | — | |
| Item | | <maxnoofTNLAssociations> | | | | |
| >>TNLA | M | | CP | CP | — | |
| Transport Layer | | | Transport | Transport | | |
| Address | | | Layer | Layer | | |
| | | | Information | Information | | |
| | | | 9.2.3.31 | as received | | |
| | | | | from NG- | | |
| | | | | RAN node₁ | | |
| TNLA Failed to | | 0 . . . 1 | | | YES | ignore |
| Setup Lis | | | | | | |
| >TNLA Failed | | 1 . . . | | | — | |
| To Setup Item | | <maxnoofTNLAssociations> | | | | |
| >>TNLA | M | | CP | CP | — | |
| Transport Layer | | | Transport | Transport | | |
| Address | | | Layer | Layer | | |
| | | | Information | Information | | |
| | | | 9.2.3.31 | as received | | |
| | | | | from NG- | | |
| | | | | RAN node₁ | | |
| >>Cause | M | | 9.2.3.2 | | — | |
| Criticality | O | | 9.2.3.3 | | YES | ignore |
| Diagnostics | | | | | | |
| Interface Instance | O | | 9.2.2.39 | | YES | reject |
| Indication | | | | | | |
| TNL Configuration | O | | 9.2.3.96 | | YES | Ignore |
| Info | | | | | | |
| Local NG-RAN | | 0 . . . | | | YES | Ignore |
| Node Identifier List | | <maxnoofLocalNG- | | | | |
| | | RANnodeID> | | | | |
| >Local NG-RAN | O | | BITSTRING | Depending | YES | Ignore |
| Node Identifier | | | (40) | on node | | |
| | | | | configuration, | | |
| | | | | the n most | | |
| | | | | significant | | |
| | | | | bits represent | | |
| | | | | the Local | | |
| | | | | Node ID | | |
| | | | | of the RAN | | |
| | | | | node. For | | |
| | | | | example, | | |
| | | | | if the | | |
| | | | | Local Node | | |
| | | | | ID is | | |
| | | | | configured | | |
| | | | | to be of 30 | | |
| | | | | bits, n == 30 | | |
| Neighbouring NG- | | 0 . . . | | | YES | Ignore |
| RAN Node | | <maxnoofNeighbouringNG- | | | | |
| Identifier List | | RANnode> | | | | |
| > Global NG- | M | | 9.2.2.3 | | — | — |
| RAN Node ID | | | | | | |
| > Neighbour NG- | M | | 9.2.2.x | | | |
| RAN Node | | | | | | |
| Identifier | | | | | | |

| Range bound | Explanation |
|---|---|
| maxnoofCellsinNGRANnode | Maximum no. cells that can be served by |
| | an NG-RAN node. |
| | Value is 16384. |
| maxnoofTNLAssociations | Maximum numbers of TNL Associations |
| | between NG-RAN nodes. Value is 32. |
| maxnoofLocalNG- | Maximum no. Local NG-RAN node IDs |
| RAN nodeID | per RAN node. Value is 1024. |

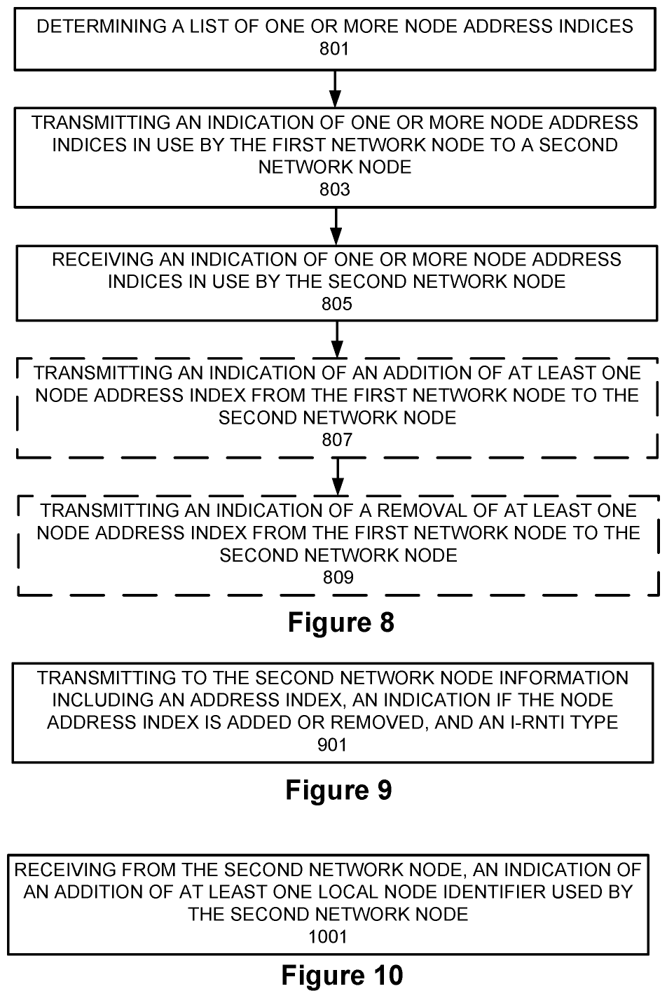

In the description that follows, while the first network node may be any of the network node 500, the network nodes 1860, 1860B, hardware 2030, or VM 2040, the network node 500 shall be used to describe the functionality of the operations of the network node. Operations of the network node 500 (implemented using the structure of FIG. 5) will now be discussed with reference to the flow chart of FIG. 8 according to some embodiments of inventive concepts. For example, modules may be stored in memory 505 of FIG. 5, and these modules may provide instructions so that when the instructions of a module are executed by respective node processing circuitry 503, processing circuitry 503 performs respective operations of the flow chart.

Turning now to FIG. 8, in block 801, the processing circuitry 503 determines a list of one or more Node Address Indices. In some embodiments of inventive concepts, determining the list of one or more Node Address Indices includes for each Node Address Index in a plurality of the one or more Node Address Indices, determining a random number as the Node Address Index.

In block 803, the processing circuitry 503 transmits an indication of one or more Node Address Indices in use by the first network node 500 to a second network node 500, 1860, 1860B, 2030, 2040. In block 805, the processing circuitry 503 receives an indication of one or more Node Address Indices in use by the second network node 500, 1860, 1860B, 2030, 2040.

In block 807, the processing circuitry 503 transmits an indication of at least one addition of at least one Node Address Index from the first network node to the second network node. The processing circuitry 503 may transmit the indication each time a Node Address Index is added, periodically, responsive to a request to update the list of one more Node Address Indices, etc.

In block 809, the processing circuitry 503 transmits an indication of at least one removal of at least one Node Address Index from the first network node to the second network node. The processing circuitry 503 may transmit the indication each time a Node Address Index is added, periodically, responsive to a request to update the list of one more Node Address Indices, etc.

Various operations from the flow chart of FIG. 8 may be optional with respect to some embodiments of RAN nodes and related methods. Regarding methods of example embodiment 1 (set forth below), for example, operations of blocks 807, 809 of FIG. 8 may be optional.

FIG. 9 illustrates an embodiment of inventive concepts of transmitting the indications. Turning to FIG. 9, in block 901, the processing circuitry 503 transmits to the second network node information including: a Node Address Index; an indication if the Node Address Index is added or removed; and an I-RNTI type.

FIGS. 10 and 11 illustrates embodiments of inventive concepts where the processing circuitry 503 receives the indications from other network nodes. Turning to FIG. 10, in block 1001, the processing circuitry 503 receives, from the second network node, an indication of an addition of at least one Local node Identifier (e.g. Node Address Index) used by the second network node.

Turning to FIG. 11, in block 1101, the processing circuitry 503 receives, from the second network node, an indication of a removal of at least one Local node Identifier (e.g., Node Address Index) used by the second network node.

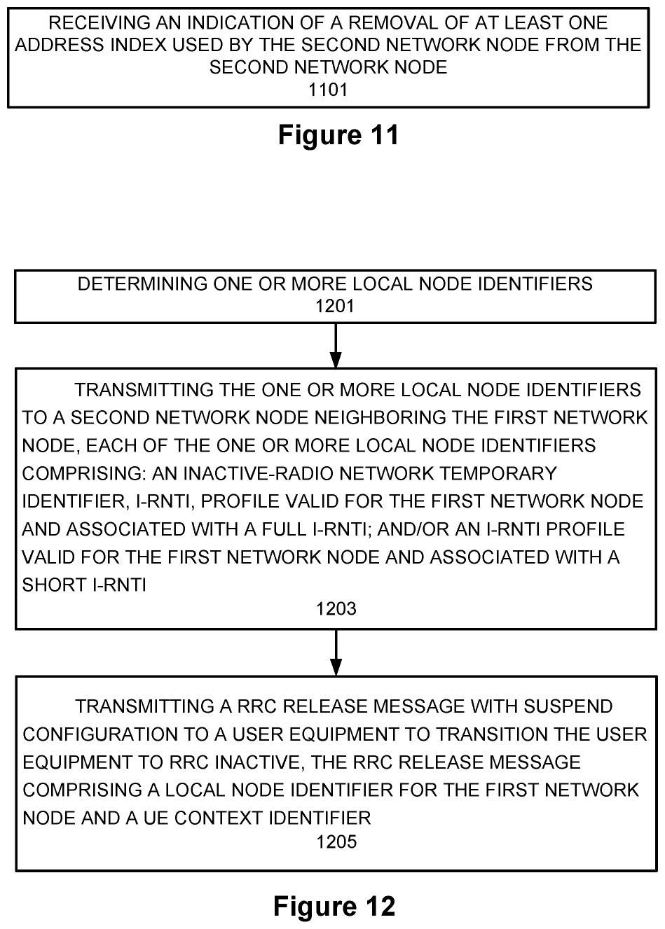

FIG. 12 illustrates an embodiment of inventive concepts where the I-RNTI profiles described above are used. Turning to FIG. 12, in block 1201, the processing circuitry 503 determines a Local node Identifier. In some embodiments of inventive concepts for some of the Local node Identifiers determined, the processing circuitry 503 determines a random number as the Local node Identifier.

In block 1203, the processing circuitry 503 transmits the one or more Local node Identifiers to a second network node 500, 1860, 1860B, 2030, 2040 neighboring the first network node, each of the one or more Local node Identifiers information including:
an Inactive-Radio Network Temporary Identifier, I-RNTI, profile valid for the first network node and associated with a full I-RNTI; and/or
an I-RNTI profile valid for the first network node and associated with a short I-RNTI.

In some embodiments, the information may include one or more of:
a Local node Identifier, valid for the first network node and associated with the full I-RNTI; and/or
a Local node Identifier valid for the first network node and associated with the short I-RNTI.

In some embodiments of inventive concepts, the information may also include one or more of: the I-RNTI profile valid for a third network node and associated with a full I-RNTI, the I-RNTI profile valid for a third network node and associated with a short I-RNTI, the Local node Identifier valid for a third network node and associated with a full I-RNTI, the Local node Identifier valid for a third network node and associated with a short I-RNTI, wherein the third network node neighbors the first network node. The third network node in some embodiments does not neighbor the second network node. In other embodiments, the third network node neighbors the second network node.

In block 1205, the processing circuitry 503 transmits a radio resource control, (RRC) release message with suspend configuration to a user equipment, to transition the user equipment to RRC Inactive, the RRC release message comprising a Local node RAN Identifier for the first network node and a UE context identifier.

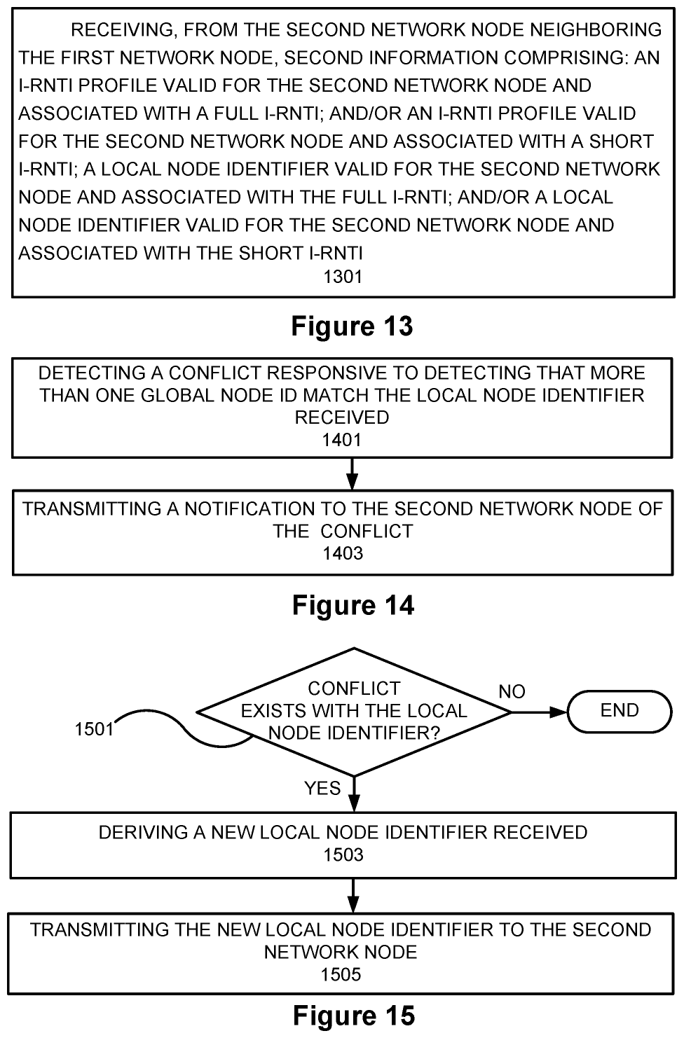

The first network node 500, 1860, 1860B, 2030, 2040 may also receive information from other network nodes. FIG. 13 illustrates some embodiments of inventive concepts where the first network node receives information.

Turning to FIG. 13, in block 1301, the processing circuitry 503 receives, from the second network node neighboring the first network node, second information including:
an I-RNTI profile valid for the second network node and associated with a full I-RNTI; and/or
an I-RNTI profile valid for the second network node and associated with a short I-RNTI.

In some embodiments, the second information may include one or more of:
a local node Identifier valid for the second network node and associated with the full I-RNTI; and/or
a local node Identifier valid for the second network node and associated with the short I-RNTI

In some embodiments of inventive concepts, the information may also include one or more of: the I-RNTI profile valid for a fourth network node and associated with a full I-RNTI, the I-RNTI profile valid for a fourth network node and associated with a short I-RNTI, the Local node Identifier valid for a fourth network node and associated with a full I-RNTI, the Local node Identifier valid for a fourth network node and associated with a short I-RNTI, wherein the fourth network node neighbors the second network node. The fourth network node in some embodiments does not neighbor the first network node. In other embodiments, the fourth network node neighbors the first network node.

In various scenarios of operation, there can be conflicts with Local node Identifiers as has been described above. FIG. 14 illustrates one embodiment of inventive concepts of detecting a conflict. Turning to FIG. 14, in block 1401, the processing circuitry 503 detects a conflict responsive to detecting that more than one Global Node ID matches the Local node Identifier received. In block 1403, the processing circuitry 503 transmits a notification to the second network node 500, 1860, 1860B, 2030, 2040, 2220 of the conflict.

FIG. 15 illustrates an embodiment of inventive concepts where a new Local node Identifier is derived when a conflict exists. Turning to FIG. 15, in block 1501, the processing circuitry 503 detects that a conflict exists with the Local node Identifier for the first network node 500, 1860, 1860B, 2030, 2040. The processing circuitry 503, responsive to detecting that a conflict exists with the Local node Identifier for the first network node, derives a new Local node Identifier in block 1503 and transmits the new Local node Identifier to the second network node 500, 1860, 1860B, 2030, 2040. The new Local node Identifier in some embodiments is derived using a random number as the Local node Identifier.

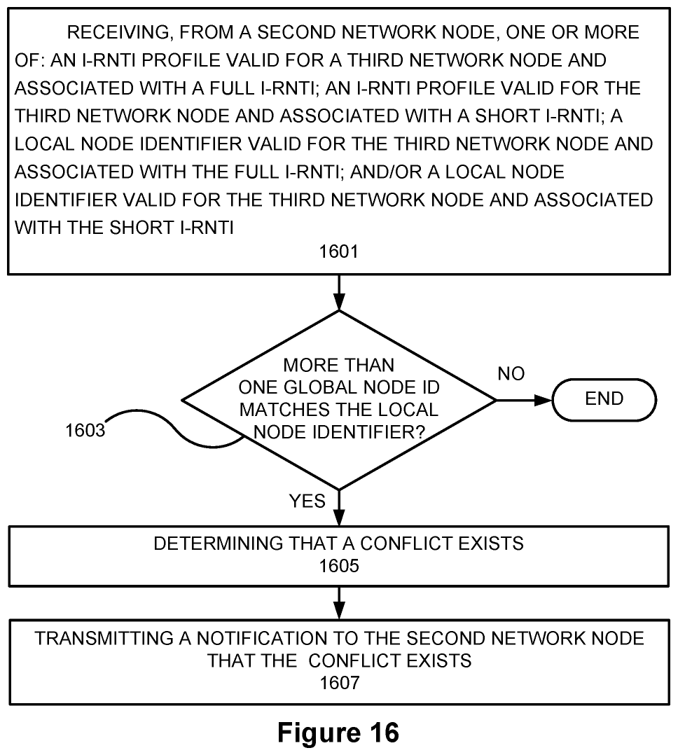

FIG. 16 illustrates another embodiment of detecting a conflict. Turning to FIG. 16, in block 1601, the processing circuitry 503 receives, from a second network node 500, 1860, 1860B, 2030, 2040 one or more of:
an Inactive-Radio Network Temporary Identifier, I-RNTI, profile valid for a third network node and associated with the full I-RNTI,
the I-RNTI profile valid for the third network node and associated with the short I-RNTI,
the Local node RAN Identifier valid for the third network node and associated with the full I-RNTI, and/or
the Local node RAN Identifier valid for the third network node and associated with the short I-RNTI, wherein the third network node neighbors the second network node;

In block 1603, the processing circuitry 503 determines whether or not more than one Global node IDs match the Local node Identifier for the third network node.

In block 1605, the processing circuitry 503, responsive to determining that more than one Global node IDs match the Local node Identifier for the third network node, determines that a conflict exists in block 1605 and transmits an indication to the second network node that the conflict exists in block 1607.

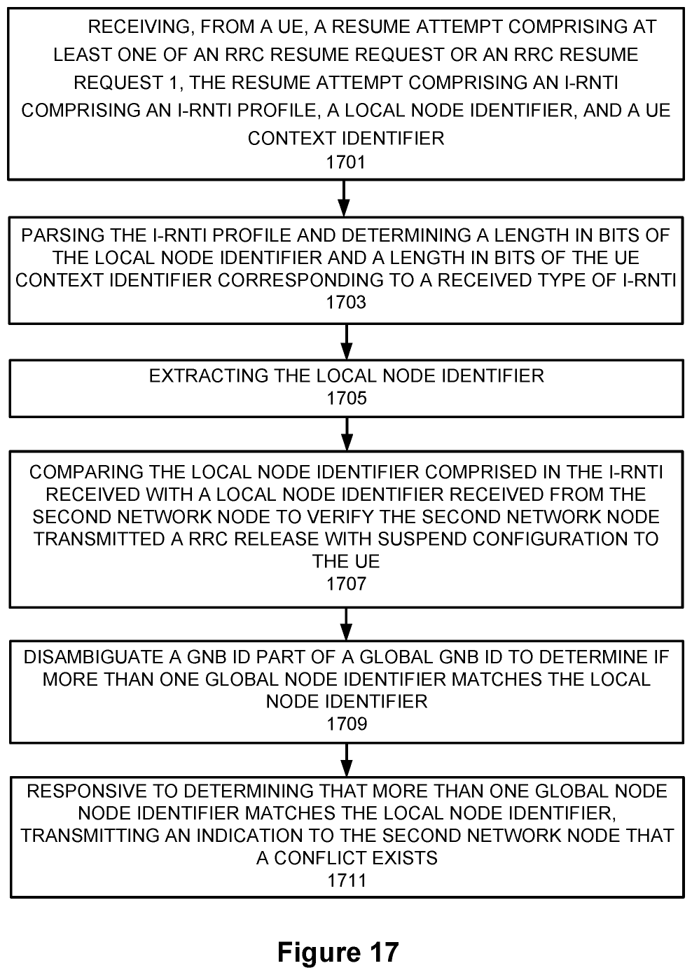

FIG. 17 illustrates a further embodiment of detecting a conflict. Turning to FIG. 17, in block 1701, the processing circuitry 503 receives, from a user equipment, UE, (400, 1810, 1810B, 1810C, 1900, 2030, 2040) a Resume attempt comprising at least one of an RRC Resume Request or an RRC Resume Request 1 comprising an I-RNTI comprising an I-RNTI profile, a Local Node Identifier, and a UE context Identifier.

In block 1703, the processing circuitry 503 parses the I-RNTI profile and determines a length in bits of the Local Node Identifier and a length in bits of the UE context identifier corresponding to a received type of I-RNTI.

The processing circuitry 503 extracts the Local node Identifier in block 1705 and in block 1707, compares the Local node Identifier comprised in the I-RNTI received with a Local node Identifier received from the second network node to verify the second network node transmitted a RRC Release message with suspend configuration to the UE.

In block 1709, the processing circuitry 503 disambiguates a gNB ID part of a Global gNB ID to determine if more than one Global node Identifier matches the local node Identifier. In block 1711, the processing circuitry 503, responsive to determining that more than one Global node Identifier matches the Local node Identifier; transmits an indication to the second network node that a conflict exists.

References are identified below.
[1] TS 38.401 v 15.4.0, 3rd Generation Partnership Project; Technical Specification Group Radio Access Network; NG-RAN; Architecture description (Release 15).
[2] 3GPP TS 38.300 v16.4.0, (2020 December) 3rd Generation Partnership Project; Technical Specification Group Radio Access Network; NR; NR and NG-RAN Overall Description; Stage 2 (Release 16).
[3] TS 38.423 v16.4.0 (2021 January) 3rd Generation Partnership Project; Technical Specification Group Radio Access Network; NG-RAN; Xn application protocol (XnAP) (Release 16).
[4] R3-206967; 3GPP TSG-RAN-WGC Meeting #110-e E-meeting, 2-12 Nov. 2020; CB: #94_LocalNodeID-Summary of email discussion.
[5] R2-206246; 3GPP TSG-RAN-WGC Meeting #110-e Online, November 2-12, 2020; Addition of Local NG-RAN Node Identifier to resolve NG-RAN ID from I-RNTI.
[6] R2-206249; 3GPP TSG-RAN-WGC Meeting #110-e Online, November 2-12, 2020; Addition of Local NG-RAN Node Identifier.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 18 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 18. For simplicity, the wireless network of FIG. 18 only depicts network 1806, network nodes 1860 and 1860b, and WDs 1810, 1810B, and 1810C (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 1860 and wireless device (WD) 1810 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1806 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1860 and WD 1810 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., mobile switching centers (MSCs), mobile management entities (MMEs)), operation and maintenance (O & M) nodes, operations support system (OSS) nodes, self-optimized network (SON) nodes, positioning nodes (e.g., evolved-serving mobile location centers (E-SMLCs)), and/or minimization of drive tests (MDTs). As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 18, network node 1860 includes processing circuitry 1870, device readable medium 1880, interface 1890, auxiliary equipment 1884, power source 1886, power circuitry 1887, and antenna 1862. Although network node 1860 illustrated in the example wireless network of FIG. 18 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1860 are depicted as single boxes located within a larger box, or nested within multiple boxes, in practice, a network node may comprise multiple different physical components that make up a single illustrated component (e.g., device readable medium 1880 may comprise multiple separate hard drives as well as multiple RAM modules).

Similarly, network node 1860 may be composed of multiple physically separate components (e.g., a NodeB component and a RNC component, or a BTS component and a BSC component, etc.), which may each have their own respective components. In certain scenarios in which network node 1860 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1860 may be configured to support multiple radio access technologies (RATs). In such embodiments, some components may be duplicated (e.g., separate device readable medium 1880 for the different RATs) and some components may be reused (e.g., the same antenna 1862 may be shared by the RATs). Network node 1860 may also include multiple sets of the various illustrated components for different wireless technologies integrated into network node 1860, such as, for example, GSM, wide code division multiplexing access (WCDMA), LTE, NR, WiFi, or Bluetooth wireless technologies. These wireless technologies may be integrated into the same or different chip or set of chips and other components within network node 1860.

Processing circuitry 1870 is configured to perform any determining, calculating, or similar operations (e.g., certain obtaining operations) described herein as being provided by a network node. These operations performed by processing circuitry 1870 may include processing information obtained by processing circuitry 1870 by, for example, converting the obtained information into other information, comparing the obtained information or converted information to information stored in the network node, and/or performing one or more operations based on the obtained information or converted information, and as a result of said processing making a determination.

Processing circuitry 1870 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1860 components, such as device readable medium 1880, network node 1860 functionality. For example, processing circuitry 1870 may execute instructions stored in device readable medium 1880 or in memory within processing circuitry 1870. Such functionality may include providing any of the various wireless features, functions, or benefits discussed herein. In some embodiments, processing circuitry 1870 may include a system on a chip (SOC).

In some embodiments, processing circuitry 1870 may include one or more of radio frequency (RF) transceiver circuitry 1872 and baseband processing circuitry 1874. In some embodiments, radio frequency (RF) transceiver circuitry 1872 and baseband processing circuitry 1874 may be on separate chips (or sets of chips), boards, or units, such as radio units and digital units. In alternative embodiments, part or all of RF transceiver circuitry 1872 and baseband processing circuitry 1874 may be on the same chip or set of chips, boards, or units

In certain embodiments, some or all of the functionality described herein as being provided by a network node, base station, eNB or other such network device may be performed by processing circuitry 1870 executing instructions stored on device readable medium 1880 or memory within processing circuitry 1870. In alternative embodiments, some or all of the functionality may be provided by processing circuitry 1870 without executing instructions stored on a separate or discrete device readable medium, such as in a hard-wired manner. In any of those embodiments, whether executing instructions stored on a device readable storage medium or not, processing circuitry 1870 can be configured to perform the described functionality. The benefits provided by such functionality are not limited to processing circuitry 1870 alone or to other components of network node 1860, but are enjoyed by network node 1860 as a whole, and/or by end users and the wireless network generally.

Device readable medium 1880 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1870. Device readable medium 1880 may store any suitable instructions, data or information, including a computer program, software, an application including one or more of logic, rules, code, tables, etc. and/or other instructions capable of being executed by processing circuitry 1870 and, utilized by network node 1860. Device readable medium 1880 may be used to store any calculations made by processing circuitry 1870 and/or any data received via interface 1890. In some embodiments, processing circuitry 1870 and device readable medium 1880 may be considered to be integrated.

Interface 1890 is used in the wired or wireless communication of signalling and/or data between network node 1860, network 1806, and/or WDs 1810. As illustrated, interface 1890 comprises port(s)/terminal(s) 1894 to send and receive data, for example to and from network 1806 over a wired connection. Interface 1890 also includes radio front end circuitry 1892 that may be coupled to, or in certain embodiments a part of, antenna 1862. Radio front end circuitry 1892 comprises filters 1898 and amplifiers 1896. Radio front end circuitry 1892 may be connected to antenna 1862 and processing circuitry 1870. Radio front end circuitry may be configured to condition signals communicated between antenna 1862 and processing circuitry 1870. Radio front end circuitry 1892 may receive digital data that is to be sent out to other network nodes or WDs via a wireless connection. Radio front end circuitry 1892 may convert the digital data into a radio signal having the appropriate channel and bandwidth parameters using a combination of filters 1898 and/or amplifiers 1896. The radio signal may then be transmitted via antenna 1862. Similarly, when receiving data, antenna 1862 may collect radio signals which are then converted into digital data by radio front end circuitry 1892. The digital data may be passed to processing circuitry 1870. In other embodiments, the interface may comprise different components and/or different combinations of components.

In certain alternative embodiments, network node 1860 may not include separate radio front end circuitry 1892, instead, processing circuitry 1870 may comprise radio front end circuitry and may be connected to antenna 1862 without separate radio front end circuitry 1892. Similarly, in some embodiments, all or some of RF transceiver circuitry 1872 may be considered a part of interface 1890. In still other embodiments, interface 1890 may include one or more ports or terminals 1894, radio front end circuitry 1892, and RF transceiver circuitry 1872, as part of a radio unit (not shown), and interface 1890 may communicate with baseband processing circuitry 1874, which is part of a digital unit (not shown).

Antenna 1862 may include one or more antennas, or antenna arrays, configured to send and/or receive wireless signals. Antenna 1862 may be coupled to radio front end circuitry 1892 and may be any type of antenna capable of transmitting and receiving data and/or signals wirelessly. In some embodiments, antenna 1862 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1862 may be separate from network node 1860 and may be connectable to network node 1860 through an interface or port.

Antenna 1862, interface 1890, and/or processing circuitry 1870 may be configured to perform any receiving operations and/or certain obtaining operations described herein as being performed by a network node. Any information, data and/or signals may be received from a wireless device, another network node and/or any other network equipment. Similarly, antenna 1862, interface 1890, and/or processing circuitry 1870 may be configured to perform any transmitting operations described herein as being performed by a network node. Any information, data and/or signals may be transmitted to a wireless device, another network node and/or any other network equipment.

Power circuitry 1887 may comprise, or be coupled to, power management circuitry and is configured to supply the components of network node 1860 with power for performing the functionality described herein. Power circuitry 1887 may receive power from power source 1886. Power source 1886 and/or power circuitry 1887 may be configured to provide power to the various components of network node 1860 in a form suitable for the respective components (e.g., at a voltage and current level needed for each respective component). Power source 1886 may either be included in, or external to, power circuitry 1887 and/or network node 1860. For example, network node 1860 may be connectable to an external power source (e.g., an electricity outlet) via an input circuitry or interface such as an electrical cable, whereby the external power source supplies power to power circuitry 1887. As a further example, power source 1886 may comprise a source of power in the form of a battery or battery pack which is connected to, or integrated in, power circuitry 1887. The battery may provide backup power should the external power source fail. Other types of power sources, such as photovoltaic devices, may also be used.

Alternative embodiments of network node 1860 may include additional components beyond those shown in FIG. 18 that may be responsible for providing certain aspects of the network node's functionality, including any of the functionality described herein and/or any functionality necessary to support the subject matter described herein. For example, network node 1860 may include user interface equipment to allow input of information into network node 1860 and to allow output of information from network node 1860. This may allow a user to perform diagnostic, maintenance, repair, and other administrative functions for network node 1860.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1810 includes antenna 1811, interface 1814, processing circuitry 1820, device readable medium 1830, user interface equipment 1832, auxiliary equipment 1834, power source 1836 and power circuitry 1837. WD 1810 may include multiple sets of one or more of the illustrated components for different wireless technologies supported by WD 1810, such as, for example, GSM, WCDMA, LTE, NR, WiFi, WiMAX, or Bluetooth wireless technologies, just to mention a few. These wireless technologies may be integrated into the same or different chips or set of chips as other components within WD 1810.

Antenna 1811 may include one or more antennas or antenna arrays, configured to send and/or receive wireless signals, and is connected to interface 1814. In certain alternative embodiments, antenna 1811 may be separate from WD 1810 and be connectable to WD 1810 through an interface or port. Antenna 1811, interface 1814, and/or processing circuitry 1820 may be configured to perform any receiving or transmitting operations described herein as being performed by a WD. Any information, data and/or signals may be received from a network node and/or another WD. In some embodiments, radio front end circuitry and/or antenna 1811 may be considered an interface.

As illustrated, interface 1814 comprises radio front end circuitry 1812 and antenna 1811. Radio front end circuitry 1812 comprise one or more filters 1818 and amplifiers 1816. Radio front end circuitry 1812 is connected to antenna 1811 and processing circuitry 1820, and is configured to condition signals communicated between antenna 1811 and processing circuitry 1820. Radio front end circuitry 1812 may be coupled to or a part of antenna 1811. In some embodiments, WD 1810 may not include separate radio front end circuitry 1812; rather, processing circuitry 1820 may comprise radio front end circuitry and may be connected to antenna 1811. Similarly, in some embodiments, some or all of RF transceiver circuitry 1822 may be considered a part of interface 1814. Radio front end circuitry 1812 may receive digital data that is to be sent out to other network nodes or WDs via a wireless connection. Radio front end circuitry 1812 may convert the digital data into a radio signal having the appropriate channel and bandwidth parameters using a combination of filters 1818 and/or amplifiers 1816. The radio signal may then be transmitted via antenna 1811. Similarly, when receiving data, antenna 1811 may collect radio signals which are then converted into digital data by radio front end circuitry 1812. The digital data may be passed to processing circuitry 1820. In other embodiments, the interface may comprise different components and/or different combinations of components.

Processing circuitry 1820 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1810 components, such as device readable medium 1830, WD 1810 functionality. Such functionality may include providing any of the various wireless features or benefits discussed herein. For example, processing circuitry 1820 may execute instructions stored in device readable medium 1830 or in memory within processing circuitry 1820 to provide the functionality disclosed herein.

As illustrated, processing circuitry 1820 includes one or more of RF transceiver circuitry 1822, baseband processing circuitry 1824, and application processing circuitry 1826. In other embodiments, the processing circuitry may comprise different components and/or different combinations of components. In certain embodiments processing circuitry 1820 of WD 1810 may comprise a SOC. In some embodiments, RF transceiver circuitry 1822, baseband processing circuitry 1824, and application processing circuitry 1826 may be on separate chips or sets of chips. In alternative embodiments, part or all of baseband processing circuitry 1824 and application processing circuitry 1826 may be combined into one chip or set of chips, and RF transceiver circuitry 1822 may be on a separate chip or set of chips. In still alternative embodiments, part or all of RF transceiver circuitry 1822 and baseband processing circuitry 1824 may be on the same chip or set of chips, and application processing circuitry 1826 may be on a separate chip or set of chips. In yet other alternative embodiments, part or all of RF transceiver circuitry 1822, baseband processing circuitry 1824, and application processing circuitry 1826 may be combined in the same chip or set of chips. In some embodiments, RF transceiver circuitry 1822 may be a part of interface 1814. RF transceiver circuitry 1822 may condition RF signals for processing circuitry 1820.

In certain embodiments, some or all of the functionality described herein as being performed by a WD may be provided by processing circuitry 1820 executing instructions stored on device readable medium 1830, which in certain embodiments may be a computer-readable storage medium. In alternative embodiments, some or all of the functionality may be provided by processing circuitry 1820 without executing instructions stored on a separate or discrete device readable storage medium, such as in a hard-wired manner. In any of those particular embodiments, whether executing instructions stored on a device readable storage medium or not, processing circuitry 1820 can be configured to perform the described functionality. The benefits provided by such functionality are not limited to processing circuitry 1820 alone or to other components of WD 1810, but are enjoyed by WD 1810 as a whole, and/or by end users and the wireless network generally.

Processing circuitry 1820 may be configured to perform any determining, calculating, or similar operations (e.g., certain obtaining operations) described herein as being performed by a WD. These operations, as performed by processing circuitry 1820, may include processing information obtained by processing circuitry 1820 by, for example, converting the obtained information into other information, comparing the obtained information or converted information to information stored by WD 1810, and/or performing one or more operations based on the obtained information or converted information, and as a result of said processing making a determination.

Device readable medium 1830 may be operable to store a computer program, software, an application including one or more of logic, rules, code, tables, etc. and/or other instructions capable of being executed by processing circuitry 1820. Device readable medium 1830 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1820. In some embodiments, processing circuitry 1820 and device readable medium 1830 may be considered to be integrated.

User interface equipment 1832 may provide components that allow for a human user to interact with WD 1810. Such interaction may be of many forms, such as visual, audial, tactile, etc. User interface equipment 1832 may be operable to produce output to the user and to allow the user to provide input to WD 1810. The type of interaction may vary depending on the type of user interface equipment 1832 installed in WD 1810. For example, if WD 1810 is a smart phone, the interaction may be via a touch screen; if WD 1810 is a smart meter, the interaction may be through a screen that provides usage (e.g., the number of gallons used) or a speaker that provides an audible alert (e.g., if smoke is detected). User interface equipment 1832 may include input interfaces, devices and circuits, and output interfaces, devices and circuits. User interface equipment 1832 is configured to allow input of information into WD 1810, and is connected to processing circuitry 1820 to allow processing circuitry 1820 to process the input information. User interface equipment 1832 may include, for example, a microphone, a proximity or other sensor, keys/buttons, a touch display, one or more cameras, a USB port, or other input circuitry. User interface equipment 1832 is also configured to allow output of information from WD 1810, and to allow processing circuitry 1820 to output information from WD 1810. User interface equipment 1832 may include, for example, a speaker, a display, vibrating circuitry, a USB port, a headphone interface, or other output circuitry. Using one or more input and output interfaces, devices, and circuits, of user interface equipment 1832, WD 1810 may communicate with end users and/or the wireless network, and allow them to benefit from the functionality described herein.

Auxiliary equipment 1834 is operable to provide more specific functionality which may not be generally performed by WDs. This may comprise specialized sensors for doing measurements for various purposes, interfaces for additional types of communication such as wired communications etc. The inclusion and type of components of auxiliary equipment 1834 may vary depending on the embodiment and/or scenario.

Power source 1836 may, in some embodiments, be in the form of a battery or battery pack. Other types of power sources, such as an external power source (e.g., an electricity outlet), photovoltaic devices or power cells, may also be used. WD 1810 may further comprise power circuitry 1837 for delivering power from power source 1836 to the various parts of WD 1810 which need power from power source 1836 to carry out any functionality described or indicated herein. Power circuitry 1837 may in certain embodiments comprise power management circuitry. Power circuitry 1837 may additionally or alternatively be operable to receive power from an external power source; in which case WD 1810 may be connectable to the external power source (such as an electricity outlet) via input circuitry or an interface such as an electrical power cable. Power circuitry 1837 may also in certain embodiments be operable to deliver power from an external power source to power source 1836. This may be, for example, for the charging of power source 1836. Power circuitry 1837 may perform any formatting, converting, or other modification to the power from power source 1836 to make the power suitable for the respective components of WD 1810 to which power is supplied.

FIG. 19 illustrates a user Equipment in accordance with some embodiments.

FIG. 19 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 19200 may be any UE identified by the 3rd Generation Partnership Project (3GPP), including a NB-IoT UE, a machine type communication (MTC) UE, and/or an enhanced MTC (eMTC) UE. UE 1900, as illustrated in FIG. 19, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 19 is a UE, the components discussed herein are equally applicable to a WD, and vice-versa.

In FIG. 19, UE 1900 includes processing circuitry 1901 that is operatively coupled to input/output interface 1905, radio frequency (RF) interface 1909, network connection interface 1911, memory 1915 including random access memory (RAM) 1917, read-only memory (ROM) 1919, and storage medium 1921 or the like, communication subsystem 1931, power source 1913, and/or any other component, or any combination thereof. Storage medium 1921 includes operating system 1923, application program 1925, and data 1927. In other embodiments, storage medium 1921 may include other similar types of information. Certain UEs may utilize all of the components shown in FIG. 19, or only a subset of the components. The level of integration between the components may vary from one UE to another UE. Further, certain UEs may contain multiple instances of a component, such as multiple processors, memories, transceivers, transmitters, receivers, etc.

In FIG. 19, processing circuitry 1901 may be configured to process computer instructions and data. Processing circuitry 1901 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1901 may include two central processing units (CPUs). Data may be information in a form suitable for use by a computer.

In the depicted embodiment, input/output interface 1905 may be configured to provide a communication interface to an input device, output device, or input and output device. UE 1900 may be configured to use an output device via input/output interface 1905. An output device may use the same type of interface port as an input device. For example, a USB port may be used to provide input to and output from UE 1900. The output device may be a speaker, a sound card, a video card, a display, a monitor, a printer, an actuator, an emitter, a smartcard, another output device, or any combination thereof. UE 1900 may be configured to use an input device via input/output interface 1905 to allow a user to capture information into UE 1900. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 19, RF interface 1909 may be configured to provide a communication interface to RF components such as a transmitter, a receiver, and an antenna. Network connection interface 1911 may be configured to provide a communication interface to network 1943a. Network 1943a may encompass wired and/or wireless networks such as a local-area network (LAN), a wide-area network (WAN), a computer network, a wireless network, a telecommunications network, another like network or any combination thereof. For example, network 1943a may comprise a Wi-Fi network. Network connection interface 1911 may be configured to include a receiver and a transmitter interface used to communicate with one or more other devices over a communication network according to one or more communication protocols, such as Ethernet, TCP/IP, SONET, ATM, or the like. Network connection interface 1911 may implement receiver and transmitter functionality appropriate to the communication network links (e.g., optical, electrical, and the like). The transmitter and receiver functions may share circuit components, software or firmware, or alternatively may be implemented separately.

RAM 1917 may be configured to interface via bus 1902 to processing circuitry 1901 to provide storage or caching of data or computer instructions during the execution of software programs such as the operating system, application programs, and device drivers. ROM 1919 may be configured to provide computer instructions or data to processing circuitry 1901. For example, ROM 1919 may be configured to store invariant low-level system code or data for basic system functions such as basic input and output (I/O), startup, or reception of keystrokes from a keyboard that are stored in a non-volatile memory. Storage medium 1921 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1921 may be configured to include operating system 1923, application program 1925 such as a web browser application, a widget or gadget engine or another application, and data file 1927. Storage medium 1921 may store, for use by UE 1900, any of a variety of various operating systems or combinations of operating systems.

Storage medium 1921 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1921 may allow UE 1900 to access computer-executable instructions, application programs or the like, stored on transitory or non-transitory memory media, to off-load data, or to upload data. An article of manufacture, such as one utilizing a communication system may be tangibly embodied in storage medium 1921, which may comprise a device readable medium.

In FIG. 19, processing circuitry 1901 may be configured to communicate with network 1943B using communication subsystem 1931. Network 1943A and network 1943B may be the same network or networks or different network or networks. Communication subsystem 1931 may be configured to include one or more transceivers used to communicate with network 1943B. For example, communication subsystem 1931 may be configured to include one or more transceivers used to communicate with one or more remote transceivers of another device capable of wireless communication such as another WD, UE, or base station of a radio access network (RAN) according to one or more communication protocols, such as IEEE 802.11, code division multiplexing access (CDMA), WCDMA, GSM, LTE, UTRAN, WiMax, or the like. Each transceiver may include transmitter 1933 and/or receiver 1935 to implement transmitter or receiver functionality, respectively, appropriate to the RAN links (e.g., frequency allocations and the like). Further, transmitter 1933 and receiver 1935 of each transceiver may share circuit components, software or firmware, or alternatively may be implemented separately.

In the illustrated embodiment, the communication functions of communication subsystem 1931 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1931 may include cellular communication, Wi-Fi communication, Bluetooth communication, and GPS communication. Network 1943b may encompass wired and/or wireless networks such as a local-area network (LAN), a wide-area network (WAN), a computer network, a wireless network, a telecommunications network, another like network or any combination thereof. For example, network 1943b may be a cellular network, a Wi-Fi network, and/or a near-field network. Power source 1913 may be configured to provide alternating current (AC) or direct current (DC) power to components of UE 1900.

The features, benefits and/or functions described herein may be implemented in one of the components of UE 1900 or partitioned across multiple components of UE 1900. Further, the features, benefits, and/or functions described herein may be implemented in any combination of hardware, software or firmware. In one example, communication subsystem 1931 may be configured to include any of the components described herein. Further, processing circuitry 1901 may be configured to communicate with any of such components over bus 1902. In another example, any of such components may be represented by program instructions stored in memory that when executed by processing circuitry 1901 perform the corresponding functions described herein. In another example, the functionality of any of such components may be partitioned between processing circuitry 1901 and communication subsystem 1931. In another example, the non-computationally intensive functions of any of such components may be implemented in software or firmware and the computationally intensive functions may be implemented in hardware.

FIG. 20 illustrates a virtualization environment in accordance with some embodiments.

FIG. 20 is a schematic block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 2000 hosted by one or more of hardware nodes 2030. Further, in embodiments in which the virtual node is not a radio access node or does not require radio connectivity (e.g., a core network node), then the network node may be entirely virtualized.

The functions may be implemented by one or more applications 2020 (which may alternatively be called software instances, virtual appliances, network functions, virtual nodes, virtual network functions, etc.) operative to implement some of the features, functions, and/or benefits of some of the embodiments disclosed herein. Applications 2020 are run in virtualization environment 2000 which provides hardware 2030 comprising processing circuitry 2060 and memory 2090. Memory 2090 contains instructions 2095 executable by processing circuitry 2060 whereby application 2020 is operative to provide one or more of the features, benefits, and/or functions disclosed herein.

Virtualization environment 2000, comprises general-purpose or special-purpose network hardware devices 2030 comprising a set of one or more processors or processing circuitry 2060, which may be commercial off-the-shelf (COTS) processors, dedicated Application Specific Integrated Circuits (ASICs), or any other type of processing circuitry including digital or analog hardware components or special purpose processors. Each hardware device may comprise memory 2090-1 which may be non-persistent memory for temporarily storing instructions 2095 or software executed by processing circuitry 2060. Each hardware device may comprise one or more network interface controllers (NICs) 2070, also known as network interface cards, which include physical network interface 2080. Each hardware device may also include non-transitory, persistent, machine-readable storage media 2090-2 having stored therein software 2095 and/or instructions executable by processing circuitry 2060. Software 2095 may include any type of software including software for instantiating one or more virtualization layers 2050 (also referred to as hypervisors), software to execute virtual machines 2040 as well as software allowing it to execute functions, features and/or benefits described in relation with some embodiments described herein.

Virtual machines 2040 comprise virtual processing, virtual memory, virtual networking or interface and virtual storage, and may be run by a corresponding virtualization layer 2050 or hypervisor. Different embodiments of the instance of virtual appliance 2020 may be implemented on one or more of virtual machines 2040, and the implementations may be made in different ways.

During operation, processing circuitry 2060 executes software 2095 to instantiate the hypervisor or virtualization layer 2050, which may sometimes be referred to as a virtual machine monitor (VMM). Virtualization layer 2050 may present a virtual operating platform that appears like networking hardware to virtual machine 2040.

As shown in FIG. 20, hardware 2030 may be a standalone network node with generic or specific components. Hardware 2030 may comprise antenna 20225 and may implement some functions via virtualization. Alternatively, hardware 2030 may be part of a larger cluster of hardware (e.g. such as in a data center or customer premise equipment (CPE)) where many hardware nodes work together and are managed via management and orchestration (MANO) 20100, which, among others, oversees lifecycle management of applications 2020.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 2040 may be a software implementation of a physical machine that runs programs as if they were executing on a physical, non-virtualized machine. Each of virtual machines 2040, and that part of hardware 2030 that executes that virtual machine, be it hardware dedicated to that virtual machine and/or hardware shared by that virtual machine with others of the virtual machines 2040, forms a separate virtual network elements (VNE).

Still in the context of NFV, Virtual Network Function (VNF) is responsible for handling specific network functions that run in one or more virtual machines 2040 on top of hardware networking infrastructure 2030 and corresponds to application 2020 in FIG. 20.

In some embodiments, one or more radio units 20200 that each include one or more transmitters 20220 and one or more receivers 20210 may be coupled to one or more antennas 20225. Radio units 20200 may communicate directly with hardware nodes 2030 via one or more appropriate network interfaces and may be used in combination with the virtual components to provide a virtual node with radio capabilities, such as a radio access node or a base station.

In some embodiments, some signalling can be effected with the use of control system 20230 which may alternatively be used for communication between the hardware nodes 2030 and radio units 20200.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method performed by a first network node comprising:
determining one or more Local node Identifiers;
transmitting the one or more Local node Identifiers to a second network node neighboring the first network node, each of the one or more Local node Identifiers comprising:
an Inactive-Radio Network Temporary Identifier, I-RNTI, profile valid for the first network node and associated with a full I-RNTI; and/or
an I-RNTI profile valid for the first network node and associated with a short I-RNTI; and
transmitting a radio resource control, RRC, release message with suspend configuration to a user equipment, to transition the user equipment to RRC Inactive, the RRC release message comprising a Local node Identifier for the first network node and a UE context identifier.

2. The method of claim 1 wherein the first network node is a first radio access network, RAN, node, the second network node is a second RAN node and the Local node Identifiers comprise NG RAN Node Local node Identifiers.

3. The method of claim 1, further comprising transmitting one or more of: a I-RNTI profile valid for a third network node and associated with a full I-RNTI, a I-RNTI profile valid for a third network node and associated with a short I-RNTI, the Local node Identifier valid for a third network node and associated with a full I-RNTI, the Local node Identifier valid for a third network node and associated with a short I-RNTI, wherein the third network node neighbors the first network node.

4. The method of claim 3 wherein the third network node does not neighbor the second network node.

5. The method of claim 3 wherein the third network node neighbors the second network node.

6. The method of claim 1, wherein determining the one or more Local node Identifiers comprises for each Local node Identifier in a plurality of the one or more Local node Identifiers, determining a random number as the Local node Identifier.

7. The method of claim 1, further comprising:
receiving, from the second network node neighboring the first network node, second information comprising:
an I-RNTI profile valid for the second network node and associated with a full I-RNTI; and/or
an I-RNTI profile valid for the second network node and associated with a short I-RNTI.

8. The method of claim 7, further comprising receiving one or more of a I-RNTI profile valid for a fourth network node and associated with a full I-RNTI, the I-RNTI profile valid for a fourth network node and associated with a short I-RNTI, a Local node Identifier valid for a fourth network node and associated with a full I-RNTI, a Local node Identifier valid for a fourth network node and associated with a short I-RNTI, wherein the fourth network node neighbors the second network node.

9. The method of claim 8 wherein the fourth network node does not neighbor the first network node.

10. The method of claim 8 wherein the fourth network node neighbors the first network node.

11. The method of claim 8 further comprising:
detecting a conflict responsive to detecting that more than one Global Node ID matches the Local node Identifier received; and
transmitting a notification to the second network node of the conflict.

12. The method of claim 1, further comprising:
responsive to detecting that a conflict exists with the Local node Identifier for the first network node:
deriving a new Local node Identifier; and
transmitting the new Local node Identifier to the second network node.

13. The method of claim 1, further comprising:
responsive to the I-RNTI profile for the first network node changing; deriving a new Local node Identifier; and
transmitting the new Local node Identifier to the second network node.

14. The method of claim 1, further comprising:
receiving, from the second network node, an indication of an addition of at least one Local node Identifier used by the second network node.

15. The method of claim 1, further comprising:
receiving, from the second network node, an indication of a removal of at least one Local node Identifier used by the second network node.

16. A first network node adapted to perform operations comprising:
determining one or more Local node Identifiers;
transmitting, to a second network node neighboring the first network node, each of the one or more Local node Identifier comprising:
an Inactive-Radio Network Temporary Identifier, I-RNTI, profile valid for the first network node and associated with a full I-RNTI; and/or
an I-RNTI profile valid for the first network node and associated with a short I-RNTI; and
transmitting a radio resource control, RRC, release message with suspend configuration to a user equipment, to transition the user equipment to RRC Inactive, the RRC release message comprising a Local node Identifier for the first network node and a UE context identifier.

17. The first network node of claim 16 wherein the first network node is a first radio access network, RAN, node, the second network node is a second RAN node and the Local node Identifiers comprise NG RAN Node Local node Identifiers.

18. The first network node of claim 16, further comprising transmitting one or more of an I-RNTI profile valid for a third network node and associated with a full I-RNTI, the I-RNTI profile valid for a third network node and associated with a short I-RNTI, a Local node Identifier valid for a third network node and associated with a full I-RNTI, the Local node Identifier valid for a third network node and associated with a short I-RNTI, wherein the third network node neighbors the first network node.

19. The first network node of claim 18 wherein the third network node does not neighbor the second network node.

20. The first network node of claim 18 wherein the third network node neighbors the second network node.

21. The first network node of claim 16, wherein determining the one or more Local node Identifiers comprises for each Local node Identifier in a plurality of the one or more Local node Identifiers, determining a random number as the Local node Identifier.

22. The first network node of claim 16, wherein the network node is further adapted to perform operations comprising:
receiving, from the second network node neighboring the first network node, second information comprising:
an I-RNTI profile valid for the second network node and associated with a full I-RNTI; and/or
an I-RNTI profile valid for the second network node and associated with a short I-RNTI.

23. The first network node of claim 22, wherein receiving the second information further comprises receiving one or more of an I-RNTI profile valid for a fourth network node and associated with a full I-RNTI, the I-RNTI profile valid for a fourth network node and associated with a short I-RNTI, a Local node Identifier valid for a fourth network node and associated with a full I-RNTI, the Local node Identifier valid for a fourth network node and associated with a short I-RNTI, wherein the fourth network node neighbors the second network node.

24. The first network node of claim 23, wherein the fourth network node does not neighbor the first network node.

25. The first network node of claim 23, wherein the fourth network node neighbors the first network node.

26. The first network node of claim 23, wherein the network node is further adapted to perform operations further comprising:
detecting a conflict responsive to detecting that more than one Global Node ID matches the Local node Identifier received; and
transmitting a notification to the second network node of the conflict.

27.-36. (canceled)
